(19) United States
(12) Patent Application Publication
(10) Pub. No.: US 2026/0175147 A1
(43) Pub. Date: Jun. 25, 2026

(54) WASTE WATER TREATMENT SYSTEM

(71) Applicant: ALTINAY SAVUNMA TEKNOLOJILERI ANONIM SIRKETI, Pendik, ISTANBUL (TR)

(72) Inventors: Alpay TARALP, Pendik, ISTANBUL (TR); Mustafa TAS, Pendik, ISTANBUL (TR); Yakup Emre AKALIN, Pendik, ISTANBUL (TR)

(21) Appl. No.: 18/836,804

(22) PCT Filed: Sep. 4, 2023
(86) PCT No.: PCT/TR2023/050901

§ 371 Date: Aug. 8, 2024

(51) Int. Cl. B01D 29/15; C02F 1/00; C02F 1/28; C02F 1/44; C02F 9/00; C02F 101/20

(52) U.S. Cl. CPC B01D 29/15; C02F 1/004; C02F 1/283; C02F 1/44; C02F 9/00; C02F 2101/20

(57) ABSTRACT

The invention relates to a water treatment system suitable for utilization in mobile platform technologies so as to remove TNT and potentially other energetic materials, toxicants and particulate matter from water and a process of utilizing said system.

### TECHNICAL FIELD

The invention relates to a water treatment system suitable for utilization in mobile platform technologies. The invention more specifically relates to a technical approach for removing TNT as well as potentially other energetic materials, toxicants and particulate matter from waste stream water and a process of utilizing said system.

### THE STATE OF ART

Typically housed in maritime shipping containers, mobile systems designed to demilitarize or to prepare munitions are marketed by various industries and made available for purchase as well as rental throughout the world (FW Holm (1997) “Mobile alternative demilitarization technologies” Springer Science+Business Media, B. V., Dordrecht; P Gobinet (2013) “Dynamic disposal: An introduction to mobile and transportable industrial ammunition demilitarization equipment” RASR Issue Brief No. 3 Technical Report, Small Arms Survey, Geneva). That being said, a mobile system specifically designed to remove TNT from pink water arising from demilitarization operations is hitherto unknown. This lack of mobile technology is unfortunate given the long-term toxicity of TNT and environmental implications of its continued entry into the ecosystem and ground water (MG Ryon, RH Ross (1990) “Water quality criteria for 2,4,6-trinitrotoluene” Regul Toxicol Pharmacol 11(2), 104-113).

Korean patent KR101382743B1 relates to a method of purifying water, which has been discolored pink for causes lying outside the scope of said invention. In their work, pink scouring resulting from dredged leachate in a closed or semi-enclosed dredged soil coastal arena is remedied.

U.S. Pat. No. 4643831A relates to a system designed for purifying water, which has not been specifically tainted by TNT. The approach taken differs substantially but nonetheless is conceptually closer to the invention than the previously mentioned Korean work. The process includes the steps of superchlorinating the water to a level sufficient to rapidly reduce bacterial content of the water, passing the water through a sand filter in which the bed medium includes beads of magnesium hydroxide, and subjecting different portions of the filtered water to differing degrees of filtration by an activated charcoal filter, whereby removal of a sufficient proportion of the chlorine added to the water reduces the residual chlorine to a level sufficient to render the water sterile without substantially influencing the taste of the water. Preferably, the sand and charcoal filters are deployed horizontally, and the depths of the filter beds are graded horizontally to introduce differing degrees of filtration of the water.

Work published as Mälardalen University Press Dissertations No. 183 (Copyright @ Olga Chusova, 2015, “Remediation of TNT-Contaminated Water by Using Industrial Low-Cost Residue Pine Bark”, ISBN 978-91-7485-226-4, ISSN 1651-4238) and publications resulting from said work (cited therein) disclose a method to purify TNT from water using low-cost pine bark residues to overcome the costs of producing and subsequently incinerating activated carbon.

Work published as a Technische Universitat Munchen Doctoral Dissertation (Copyright @ Xuemin Xiang, 2001, “Treatment of Trinitrotoluene (TNT)-contaminated Wastewater in Constructed Wetland”) and publications resulting from said work (cited therein) disclose biological processes to remediate and thus enzymatically decompose environmental TNT into harmless byproducts.

L S Hundal et al. (“Removal of TNT and RDX from Water and Soil Using Iron Metal”, Environmental Pollution 97(1-2), 55-64, 1997) disclose a method to chemically degrade TNT and RDX in environmental water using the combined action of elemental iron and hydrogen peroxide.

Finally, M Zhang et al. (“Organic pollutants removal from 2,4,6-trinitrotoluene (TNT) red water using low cost activated coke”, Journal of Environmental Science (China) 23(12), 1962-1969, 2011) disclose a process to chemisorb and thereby remove environmental TNT and other toxicants from red water using activated coke.

Q Zhang et al. (“Modification of a Na-montmorillonite with quaternary ammonium salts and its application for organics removal from TNT red water”, Water Science Technology 69(9), 1798-804, 2014) disclose a process to prepare and subsequently utilize chemically modified sodium montmorillonite in order to remove toxicants from red water.

None of the above prior art technologies are practical to the extent of providing a cost-effective yet easily adoptable and general scope viable solution to the treatment of pink water. Since current approaches to purifying pink water waste streams cannot resolve all challenges relating to practical constraints such as location, cost-efficiency, start-up time, etc., further improvements are sought in the technical field. In addressing this dearth in the field, a mobile pink water treatment system utilizing readily accessible consumables has been cost-effectively constructed out of modular parts and successfully tested.

### PURPOSE OF THE INVENTION

Said invention aims to introduce a generally applicable, wide scope and affordable solution to the treatment of pink water so as to resolve shortcomings inherent to the present state of the art.

The main objective of the invention is to provide a pink water treatment system suitable for utilization in mobile platform technologies. Said system can be rapidly set-up and used at any location to remove TNT, other energetics, and potentially other toxicants and particulate matter from pink water or potentially other forms of waste stream water. Hence, a readily integrable water treatment system (or alternatively, an emergency backup secondary system) and a process of utilizing said system, either alone or together with other demilitarization systems, is obtained in the invention.

To summarize the problem, sub-stations (i.e., work stations) making up a water treatment system were connected in a specific, mandatory order to enforce the stepwise purification of a pink water waste stream. Said sub-stations were made as independently-standing modules so as to permit the facile arrangement and assembly of the water treatment system in any suitable volume space. In the particular system tested, a prototype occupying the floor area of two 40′ containers was constructed. Seamless intra-system connectivity of the modular parts was ensured via an easily modified conduit system. While modularity greatly facilitated the compact spatial arrangement and connectivity of the individual sub-stations, the limited 2.5 meter floor-to-ceiling height of the maritime shipping container posed a problem; namely, prior work irrefutably confirmed that a flocculation tank measuring >3.5 meters in height is mandatory to efficiently remove TNT flocs at the targeted hourly capacity. With little choice in the matter and no clear solution to remedy these opposing size constraints, a flocculation tank was designed and constructed to fit inside the confines of a standard shipping container. As anticipated, sub-standard floc removal ensued, which in turn prompted a higher-than-normal solids content in the exit stream of the flocculation tank and thus introduced unacceptable burden and operating inconveniences to the downstream sub-stations and to the system as a whole. Said invention highlights a filter sheet-enhanced sand filter sub-station for deployment in a shipping container. Said sand filter sub-station is positioned immediately downstream of the flocculation tank and boasts technical developments honed to resolve the practical limitations of the state of the art and the unfortunate performance limitation associated with the construction of mobile units with sub-optimally short flocculation tanks. Other features promoting the mobility of said water treatment system include design modularity and seamless connectivity of the sub-stations. The modularity of the system permits layout flexibility in the sense that system containment is not limited to the confines of maritime shipping containers. Indeed, many potentially different volume spaces can be used to house said purification system, albeit, a shipping container is the only “mobile” format, which is readily shippable worldwide.

The completed mobile water treatment system consists of functionally differing sub-stations, with each sub-station utilizing a different technique to remove impurities from water. Each sub-station is appropriately connected to one another, establishing an effective purification train. It is this mandatory arrangement of processes-flocculation, sand filtration, ultrafiltration, nanofiltration, and granulated active carbon treatment-which ultimately enforces the efficient, incremental purification of pink water. In the configuration adopted, sub-stations inherently possessing a high solids removal capacity serve to remove the brunt of TNT from the waste stream. These sub-stations are arranged at the front of the train according to their relative solids removal capacity, with the highest capacity sub-station being located at the forefront and lesser capacity sub-stations being arranged thereafter in decreasing order. Conversely, sub-stations designed for higher purity filtrate production are fundamentally more limited in their loading capacity and cannot tolerate substantial impurities in the waste stream. Accordingly, these sub-stations are arranged at the end of the train in a manner again reflecting their relative solids loading capacity. This mandatory connectivity of sub-stations in the train thus strikes a happy balance between managing solids loading capacity demands and meeting purification constraints in the sense that each downstream sub-station along the train is designed to purify better than the former sub-station but designed to handle less impurity per unit volume of waste stream. The combination thus obtained (FIG. 1), yields an arrangement of sub-stations whose output or filtrate clearance rates are comparable to one another as opposed to being undesirably disproportionate, thereby minimizing the total down time needed for system maintenance. The seamless, i.e., fully integrated/connected operation of sub-stations further adds to the convenience of the system.

The enabling feature of this invention is a sand filter fitted with a removable filter sheet overlay. Surprisingly, said filter sheet overlay restores a desired level of operating convenience to the whole system by enabling the sand filter sub-station to tolerate much higher solid loadings as well as waste-stream feed rates into the sand filter bed compared to an equivalent sand filter operating without a filter sheet overlay. By directing the deposition of suspended solids to a limited area and enforcing rapid filtration in the surrounding region, said sand filter system prompts a regionally focused and unusually large solids accumulation over the centralmost region of the sand bed. Said accumulation, i.e., a “hill-shaped” filter cake, is allowed to grow until such a time as the region surrounding the filter cake becomes too small (or plugged) to sustain a threshold filtration rate. The ability to accumulate a large mass of solids before engaging in down time for cake retrieval contrasts against typical prior art filtration applications, which yield a flat filter cake of limited mass spread over the entire bed. Not only are larger cakes obtained for a given bed size, but less total down time is required for maintenance in between filtration rounds. Filter sheets used as sand bed overlays are readily retrievable; integration into the sand filter sub-station enabled the rapid removal of filter cakes. Moreover, the availability of clean filter sheet replacements further added to the speed and convenience of the maintenance process. By contrast, standard sand filter system designs are subjected to rapid sand surface fouling by the waste stream. Sand bed coverage by inherently soft/sticky solids such as “muddy” TNT particles prompts the blockage of channels separating the sand particles. When allowed to continue, this undesired event causes premature plugging of multiple layers of sand, induces sluggish filtration through the sand layers, and impedes the rapid discharge of filtrate. Consequently, frequent and extensive sand bed servicing becomes a routine in which whole sand layers are replaced in order to continue filtration operations. As maintenance is invoked prematurely, filter cakes are extracted before reaching their targeted, optimally large mass.

Given the above, the filter sheet overlay of the invention clearly protects the milliard of percolation channels made up by the neighboring grains of sand in the sand filter. In addition to preventing fouling, the filter sheet overlay also provides a less permeable “skin” at the sand surface, which acts to divert the waste stream normal to the force of gravity. In other words, the waste stream is shunted to the outskirts of the sand bed. For purposes of said invention, shunted waste stream may be considered as surface “run-off”. Without the filter sheet in place, waste stream would continue downwards into the sand filter. Diverting the flow in this manner has the effect of isolating the sand bed into a centralmost region used to build a filter cake and a surrounding region used to rapidly discharge the solids-depleted stream. Continuous sedimentation of suspended solids is realized throughout the radially outwards journey of said run-off, with the greatest separation of solids being realized at the sand bed center. Over time, a centralized filter cake incrementally grows for as long as the filtration operation is continued. The overlay also permits rapid, safe and complete removal and recovery of filter cakes, some which may comprise of explosives.

The principle features enabling said invention comprise of a filter sheet (8) overlaid along a sand bed (10.1) (FIG. 3). Said filter sheet (8) is slightly undersized compared to the sand bed (10.1) and is positioned such that the centers of filter sheet (8) and sand bed (10.1) overlap. Each filter sheet edge and proximal sand bed edge are parallel oriented with respect to each other. In other words, the filter sheet and sand bed are concentric. The sand bed is further sub-divided (i.e., demarcated) into zones such as the central region, the ring region, the centralmost region (i.e., the sum of central and ring regions), the periphery region, and the perimeter region (FIG. 2). In configuring the sand filter, an appropriately undersized filter sheet is draped along the sand bed (not shown). Properly positioned, the sheet edges will overlap/trace out the boundary line of the perimeter region-periphery region border. Accordingly, the outermost area of the sand bed, dubbed herein as the perimeter region (FIG. 2), remains the sole part of the bed not covered by filter sheet. The center point of the sand bed/filter sheet is further positioned under an open-ended, wide-diameter waste stream feed pipe (6) or any suitably designed open-ended feed channel/source (FIG. 3). Said pipe is appropriately positioned such that the waste stream feed pipe opening (6.1) is concentric with the sand bed/filter sheet center, and held above the bed at an atypically high distance (h) compared to sand filtration systems of the prior art. Based on the operating parameters and personal preferences, the pipe opening may be oriented to face downwards, upwards or any angle in between. The open pipe end serves to gravity-drop the waste water stream onto the filter sheet, prompting the central accumulation of solid particles and growth of a centralized filter cake. Herein the term gravity-drop relates to any scenario in which waste stream is released and allowed to freely fall under the influence of gravity such that the impact force of the stream, in striking the filter sheet, is almost entirely determined by gravity and opposed to other factors such as the pressure driving the influx stream through a conduit. For this reason, the stream delivery pipe should have a sufficiently wide diameter so as to minimize any force contribution of non-gravitational factors, which otherwise would increase impact forces. In our experience, the stream delivery pipe employed could be narrower than the ideal width, provided that the open end is formed out of a tapered length of piping (i.e., the open end is “tapered up”, with the major diameter of the tapered length defining the side of the pipe opening, and the minor diameter defining the side where tapered and standard piping make contact). With this alternative piping, a minor diameter/major diameter/taper length ratio of 1:2:3 performed adequately. That being said, a person knowledgeable in the field can implement many approaches to limit or negate non-gravimetric forces potentially adding to the impact force of the descending stream. While the filter sheet permits convenient removal of filter cake from the underlying sand filter, a more subtle secondary benefit is that it greatly limits any physical disruption of the sand filter surface. In particular, the overlaid filter sheet (8) prevents any distortion/deformation/pitting of the fine sand layer (10), whose top is the surface defining the sand bed (10.1). Without a filter sheet overlay acting as a physical barrier, said fine sand layer would be subjected to substantial impact forces imposed by the gravity-dropped stream.

In any filtration operation, a waste stream is gravity-dropped along the central region (10.1.1) or possibly the wider centralmost region (10.1.3) of a sand bed (10.1). The sand bed is overlaid with a filter sheet (8), which is comparatively slightly undersized. The filter sheet concurrently mediates through-sheet passage of stream as well as radially outwards flow of stream along the sheet to the outskirts of the sand bed. At any particular site along the filter sheet, the fraction of stream experiencing through-sheet filtration compared to the fraction flowing outwards as surface run-off varies according to the extent of waste water solids deposited at that site. The extent of deposition in turn varies according to the distance from the sand bed center and completeness/current stage of the filtration operation. Surrounding the central region of the sand bed is the narrow ring region (10.1.2) of the sand bed. The filter cake girth defines the outer boundary line of the ring region. Over time as girth increases, the ring region expands to compensate. Beyond the ring region are the outskirts of the sand bed. The inner fraction of said outskirts is overlaid by the remainder of the filter sheet. The portion of sand bed underlying the remainder of sheet and enclosing the ring region of the sand bed is dubbed the periphery region (10.1.4). The outer fraction of said outskirts is not covered by sheet and defines the aforementioned perimeter region (10.1.5). The perimeter region encloses the periphery region and edges of the filter sheet overlay. Said perimeter region delineates the only region of exposed sand, and it is in turn surrounded by the sand filter perimeter wall (9). The combination of sand-exposed perimeter region and sheet-overlaid periphery region making up said outskirts by enlarge define freely filtering surfaces. The term “by enlarge” has been used here to account for the unavoidable and sporadic marginal deposition of waste stream solids beyond the filter cake site. In any case, it should be clear that run-off of stream can readily access filter sheet surface overlying the periphery region. Similarly, run-off can readily access the exposed sand surface of the perimeter region. The combined periphery and perimeter regions respectively mark out a sheet-covered and sand-exposed bed whereof surface run-off filtration events assume slightly different modes and flux limits as a function of position. The periphery region delineates that domain where surface run-off of waste stream passes most easily through the filter sheet to the underlying sand bed. Moving outwards, the perimeter region delineates a domain where surface run-off directly contacts exposed, accessible regions of sand. Hence, the perimeter region defines an exposed, accessible and readily penetrable sand bed region, which expedites the filtration process. Under the assistance of a vacuum pump (13), surface run-off from the waste stream rapidly descends beneath the sand bed and exits the sand filter as a partially purified filtrate (15). It should be emphasized that suspended solids initially present in the waste stream continually settle as stream flows radially outwards; the process is easily adjusted such that surface run-off arriving at the periphery and perimeter regions will have become substantially solids-depleted and thus non-plugging. Indeed, said perimeter region is surprisingly less prone to fouling and channel plugging because of the solids-depletion event.

Appropriately operated, the perimeter and periphery regions are remarkably disinclined to plugging. Consequently, waste stream does not accumulate in the filter bed. A direct benefit of suppressed plugging and stream accumulation, albeit non-obvious, is process prolongation. Process prolongation in turn makes possible the substantial incremental upwards and outwards growth of the centrally located filter cake. Indeed, with an appropriately chosen filtration flux, sand bed-to-filter sheet surface area ratio, and waste stream drop height (h) (with “appropriately” denoting a suitably narrow range), the sand filter simultaneously experiences (i) centralized accumulation of solid particles along the filter sheet, (ii) radial transfer of the solids-reduced waste stream to the periphery and perimeter regions, and (iii) rapid discharge of a partially purified waste stream from the sand filter. Again, it should be emphasized that a proper choice of values for the above operating parameters permits the prolonged deposition of solids along the filter sheet and formation of a large-mass filter cake. Once the filter cake becomes sufficiently massive, the filtration operation may be shut down for maintenance so that another round may commence. Here, “maintenance” refers to retrieval of the cake and any incidental servicing of the sand bed. In addition to time-saving conveniences provided by the filter sheet (easy cake removal and rapid sand bed restoration), a particular benefit of yielding large filter cakes during a filtration round is the low frequency of down times required for maintenance. Here, “down times” refers to periods in between filtration operations. Given that these features of the sand filter sub-station restore operating convenience to a practically acceptable level, it follows to re-emphasize that the waste water treatment system of said invention has the necessary design features to be conveniently utilized inside standard shipping containers as well as other similarly height-constrained volume spaces, which challenge the efficient operation of height-requiring equipment such as a flocculation tank. It further follows to reason that a sand filter configured as expressed herein could even preclude the need of a preceding flocculation tank in cases where the untreated waste stream already has a low solids content. In such instances, the sand filter sub-station would significantly contribute to the space economy of the overall waste water purification process.

For purposes of said invention, stream-suspended solids subjectable to physical removal by sand filter processing refer primarily to ≥10 and possibly ≥5 micron-sized particulate TNT or other similarly sized organic/inorganic particles comprising of energetic, toxic or inert materials. That being said, an expert in the field will recognize that the sub-stations comprising said invention and particularly those following said sand filter sub-station will target and remove progressively smaller and smaller particles, eventually sequestering out even single molecules at the final sub-station via physico-chemical interactions. An expert in the field will also recognize that the sand filter sub-station as well as the invention as a whole can be applied to purify waste water containing almost any class of suspended energetic, toxic or inert solid. An expert in the field will also recognize that said invention is readily scalable.

The structural and characteristic features of the invention and associated advantages can be better grasped by referring to the figures drawn below as well as the detailed written explanations corresponding to said figures and events portrayed therein. The invention can be better appreciated and evaluated by considering said figures and detailed descriptions.

### REFERENCE NUMERALS

1 Flocculation tank sub-station
2 Sand filter sub-station
3 Ultrafiltration sub-station
4 Nanofiltration sub-station
5 Active granular carbon purification sub-station
6 Waste stream feed pipe
   6.1 Waste stream feed pipe opening
7 Waste stream
   7.1 Surface run-off
   7.2 Entry into sand
8 Filter sheet
9 Perimeter wall
10 Fine sand layer
   10.1 Sand bed (i.e., top surface of 10)
   10.1.1 Central region
   10.1.2 Ring region
   10.1.3 Centralmost region
   10.1.4 Periphery region
   10.1.5 Perimeter region
11 Coarse sand layer
12 Fine gravel layer
13 Vacuum pump
14 Air flow
15 Filtrate
16 Filter cake
17 Stream accumulation along the sand bed
18 Stream flooding of the sand bed

### FIGURES FACILITATING COMPREHENSION OF THE INVENTION

FIG. 1 is a process flow diagram depicting the connectivity of five sub-stations comprising the waste water purification system. Each sub-station, named as per the Reference Numerals section, item 1-5, depicts a functionally distinct and independently operational unit. Each sub-station contributes to the overall waste stream purification via a distinctly different process. For illustrative purposes, an exemplary pink water waste stream has been indicated as input.

FIG. 2 represents the top/aerial view of the sand bed (10.1) taken from a central position. From this perspective, one may note the comprehensive demarcation (dotted lines) of the sand bed into a central region (10.1.1), ring region (10.1.2), centralmost region (10.1.3), periphery region (10.1.4) and perimeter region (10.1.5). Also emphasized in this downwards view is the enclosure of the sand bed by the perimeter wall (9) of the sand filter (2). In this depiction, the ring region surrounds the central region. The sum of ring and central regions (10.1.1 and 10.1.2, respectively) defines the centralmost region (10.1.3). The periphery region (10.1.4) encloses the ring region (10.1.2). The outer boundary line of the periphery region is defined by the edges of a slightly undersized filter sheet (8) (not shown), which is concentrically draped over the sand bed (10.1). Surrounding the periphery region is the perimeter region (10.1.5) of the sand bed. Said perimeter region is undraped by sheet and extends outwards to the perimeter wall (9). The sand bed (10.1) is closely related to the fine sand layer (10) in the sense that the sand bed is the top surface of the fine sand layer. In other words, an aerial view of the sand bed automatically implies a view of the top surface or face of the fine sand layer. In the interest of simplicity, here forth the top surface of the fine sand layer shall be specified as the sand bed. It should be clear that the sand bed is a surface, and moreover, said surface is the sum of regions numbered as 10.1.1, 10.1.2, 10.1.4 and 10.1.5, the lattermost region being enclosed by the perimeter wall (9). The fine sand layer (10), sand bed (10.1) and filter sheet (8) have been explicitly numbered in FIG. 3, where there is no potential for confusion. It is the surface area discrepancy between the sand bed (10.1) and filter sheet (8), which defines the perimeter region (10.1.5), the only region of the sand bed (10.1) whereof the fine sand layer (10) is exposed because the surface is not covered by sheet. Thus, the perimeter region lacks a filter sheet overlay and features a surface comprising of exposed fine sand. More importantly, the perimeter region can discharge surface run-off (7.1) faster than the periphery region, which is relatively flux-limited due to the added contribution and bottle-neck effect of a filter sheet overlay. It should be emphasized that FIGS. 2 and 3 have been sketched in their current form to aid comprehension, however, both drawings are in fact oversimplifications, the reason being that most demarcated regions of said sand bed owe their existence, by definition, to the presence of a filter cake. As both figures reflect an inoperative phase (i.e., before the onset of filtration), the sand bed demarcation convention does not, as of yet, apply. Boundary lines defining said regions acquire meaning only after a filter cake materializes in the bed. The one exception is the perimeter region, which is defined not by the size of the filter cake, but rather, by the edges of the overlaid, slightly smaller filter sheet and the perimeter walls of the sand bed.

FIG. 3 illustrates the cross-section of an idle sand filter (2) just before commencing another filtration round (i.e., after post-filtration maintenance operations have been completed from the previous round). Noteworthy is the overhanging waste stream delivery pipe (6) and delivery pipe opening (6.1), the sand filter perimeter wall (9), three horizontally striated layers of filtration media (labelled separately as 10-12), the sand bed (10.1) (shown here as the top face of the fine sand layer, 10), the filter sheet (8), shown as a slightly undersized overlay, the sand bed central region (10.1.1), the sand bed ring region (10.1.2), the sand bed periphery region (10.1.4), the sand bed perimeter region (10.1.5), and lastly the vacuum pump (13), which has been included for the sake of completeness. Said vacuum pump (13) is used only when operating the sand filter (2).

FIG. 4 illustrates the cross-section of a sand filter (2) sub-station in the midst of operation. Waste stream (7) is delivered by a waste stream feed pipe (6) or any other suitably shaped conduit. Said stream flows over the sand bed and quickly percolates downwards through the sand filter body under the assistance of a vacuum pump (13). Filtrate (15) exiting the sand filter is partially purified. Said filtrate (15) is pure enough to be processed further by the neighboring down-stream positioned ultrafiltration sub-station (3). Likewise, the output of the ultrafiltration sub-station will be pure enough for processing by the down-stream positioned nanofiltration sub-station (4) and subsequent active granular carbon purification sub-station (5). Experience confirmed that the sand filter (2), appropriately used, prompted long-term maintenance-free performance of the down-stream sub-stations. Capacity limits were never approached. Emphasized in FIG. 4 is the sand bed (10.1), which is overlaid by a filter sheet (8) of slightly smaller surface area. Further outlined is the central region (10.1.1) and ring region (10.1.2) of the bed. While not explicitly numbered, the sum of the ring and central regions defines the centralmost region of the bed (10.1.3). Also highlighted is the periphery region of the bed (10.1.4) and the perimeter region of the bed (10.1.5). The perimeter region depicts that part of the sand bed, which has no filter sheet overlay. The process begins at the waste stream feed pipe (6), which serves to drop waste stream (7) onto the bed of the sand filter via the waste stream feed pipe opening (6.1). Having arrived at the bed, the waste stream flows as surface run-off (7.1) initially along the slope of the growing filter cake (16) and thereafter along the surface of the filter sheet (8). Said surface run-off (7.1) flows radially outwards, as implied by the multi-arrow-headed thin lines in FIG. 4. Said outwards flow of surface run-off occurs freely and radially in all directions beginning at the central region and terminating at the perimeter wall (9). Stream entry into sand (7.2), as implied by parallel single-arrow-headed thin lines, occurs concurrent as well as subsequent to the surface run-off (7.1) event. Moreover, stream entry into sand (7.2) occurs at exposed as well as sheet-overlaid regions of the bed. At exposed sand sites, stream entry into the sand (7.2) follows the surface run-off event (7.1). In regions overlaid by filter sheet (8), stream entry into sand (7.2) follows a compulsory order in which surface run-off (7.1) initially transcends the filter sheet overlay to make contact with underlying sand. On a more general note, the filtration flux at any particular point along the filter sheet is an event, which is influenced by the loading of solids at that particular point of the filter sheet. For purposes of said invention, significant through-sheet flux commences along that part of sheet overlying the ring region. Through-sheet flux incrementally increases in proceeding outwards from the ring region. In contrast, through-sheet flux occurring inside of the ring region is sufficiently impeded by the large accumulation of cake thereon so as to be considered negligible. Also shown in FIG. 4 is the discharge of waste stream (7) as filtrate (15). Delivery of waste stream (7), exit of filtrate (15), and deposition/growth of a filter cake (16) have been highlighted using thick arrows. Abrupt directional changes of stream flow, i.e., surface run-off (7.1) and entry into sand (7.2) have been highlighted using thin lines. As implied by numerous short thin arrows, stream entry into sand (7.2) occurs at exposed regions (i.e., the perimeter region, 10.1.5) as well as sheet-overlaid regions (i.e., the periphery and ring regions). All thin arrow types (long and short) were drawn to illustrate the direction of localized flow. Their number or density around a particular site should not be equated with flow flux at that particle site.

FIG. 5 portrays the same filtration process using a sand filter (2) with a smaller-sized sand bed (10.1) and correspondingly smaller filter sheet (8). The same influx rate of the waste stream (7) applies as that depicted in FIG. 4.

FIG. 6 portrays a failed filtration process utilizing still a smaller sized sand bed (10.1) compared to FIG. 5 and a correspondingly smaller filter sheet (8). Again, the stream influx rate is the same as the previously shown two filtration operations.

FIG. 7 compares the empirically-determined performance of different sand filters as a function of the sand bed area. Namely, FIG. 7 plots the mass of filter cake divided by the sand bed area (kg/m²) versus the sand bed area (m²). In other words, said figure plots the mass of cake accumulated per unit area of bed versus the total bed area, where “mass” refers to the surface-averaged value taken over the entire bed. Trials utilized the same pink water waste stream influx rate. Filtration was terminated and measurements taken once the maximum allowable mass of cake had accumulated in the bed. The maximum allowable accumulation was defined as the point at which the sand bed was deemed as being loaded or saturated to the extent that further loading of solids would prompt stream flooding of the bed. The profile shows a distinct break in the curve, confirming that an optimum sand bed area exists for a given stream influx rate. By “optimum”, one means to signify the smallest area of bed (i.e., most efficient use of space) affording a given mass of cake, with other parameters held constant. Further discussion is below in the teachings section.

### DETAILED EXPLANATION OF THE INVENTION

In this section, the preferred embodiment of the invention is clarified such that there is no limiting effect opposing a better understanding of the subject.

The invention relates to a waste water treatment system suitable for utilization in mobile platform technologies. Said system can be used to remove TNT and potentially other energetics, toxicants and particulate matter from waste water streams and particularly from pink water waste streams. The invention also relates to a process of utilizing said system to achieve said purification. Said system comprises the compulsory-ordered connection of modular sub-stations, with each sub-station performing a different purification task. The resultant sequence forms a processing train, which incrementally realizes the targeted level of purification. The sub-stations of said train are listed below, beginning with the most upstream sub-station and ending with the most downstream:
At least one flocculation tank sub-station (1), optionally,
At least one sand filter sub-station (2), with said sub-station additionally featuring,
   A filter sheet (8), positioned under a waste stream feed pipe opening (6.1), and concentrically draped along a similarly-shaped sand bed, configured such that the gap separating sheet and pipe opening is the waste stream drop height, h, and also configured such that said sheet is slightly undersized so as to cover 92-97% of the sand bed (10.1), and further configured such that the fraction of sheet draped along the centralmost region (10.1.3) of the sand bed serves as the site to feed the waste stream (7) and to support the deposition and growth of filter cake (16) displaying a hill-like cross-section, and further still configured such that the fraction of sheet draped along the ring region (10.1.2) and periphery region (10.1.4) of the bed permits through-sheet transfer of stream to the underlying periphery region and lateral transfer to the undraped perimeter region (10.1.5) of the bed, and furthermore configured with a vacuum pump (13) to speed the flow of stream through all filtration media and to discharge filtrate (15) at the sand filter base; the effect of the above features and configurations being to extend filtration times and operating capacity, to maximize cake growth, to reduce maintenance down times, and to raise the efficiency and utility of the filtration rounds,
At least one ultrafiltration sub-station (3),
At least one nanofiltration sub-station (4), and
At least one active granular carbon purification sub-station (5).

As surmised from above, the heart of the invention is the sand filter sub-station. The dynamics of filtration are complex, as waste stream entering the sand bed region is simultaneously subjected downwards as well as lateral flow. In defining the filtration process beyond the level of detail required for the claims section, one may express the filtration setup as a filter sheet (8), slightly undersized compared to the sand bed of the sand filter, overlaid directly along the sand bed (10.1) so as to cover 92-97% of the total available sand bed (10.1), configured such that the center points of filter sheet (8) and sand bed (10.1) overlap, and further configured such that the region filter sheet (8) covering the centralmost region (10.1.3) of the sand bed (10.1) of the sand filter (2) serves as the site to drop/deliver waste stream (7) as well as the site for the buildup of a hill-shaped filter cake (16). The centralmost region is also the point at which the flow of the waste stream randomizes and disperses substantially. Starting at the ring region (10.1.2) and extending to regions beyond, the waste stream is radially conveyed outwards over the growing filter cake and surrounding filter sheet, eventually transcending the periphery region (10.1.4) and arriving at the perimeter region (10.1.5). Filter sheet (8) covering the periphery region (10.1.4) serves to convey stream downwards to the underlying sand bed (10.1) via through-sheet filtration so that stream may discharge thereafter from the sand filter. As well, waste stream (7) continues radially outwards along the sheet (8) to the perimeter region (10.1.5). Once there, exposed sand making up the undraped perimeter region (10.1.5) freely contacts and mediates the rapid flow of waste stream (7) into the sand bed, again prompting the discharge of waste stream (7) from the sand filter (2) as filtrate (15). Radially conveyed stream has been dubbed herein as surface run-off (7.1) and is represented diagrammatically as long thin lines with multiple arrow heads. Stream entering the sand bed (7.2) has been shown diagrammatically by short thin single-arrow-head arrows.

A process of utilizing said waste water treatment system of the invention is characterized in that a waste water stream (7) is sequentially conveyed via a waste stream feed pipe (6) or any suitably appropriate alternative conduit to various sub-stations, connected in the order shown below, and processed thereof such that:
Optionally, the flocculation tank sub-station (1) is included and used to generate flocs and thereby achieve a partial purification via precipitation and removal of said flocs,
The sand filter sub-station (2), configured with an overlying filter sheet (8) covering 92-97% of the total sand bed (10.1), and an open-ended waste stream feed pipe (6) or suitable alternative stream delivery/feed element positioned centrally above the sand bed (10.1) and suspended by a vertical distance corresponding to a waste stream drop height, h, where h is ¼ to ⅓ of the dimension of the filter sheet (8), is fed the incoming waste water stream (7) (said stream is considered partially purified if a flocculation tank precedes sand filtration) such that the waste water stream (7) drops onto filter sheet (8) covering the central region (10.1.1) and possibly the larger centralmost region (10.1.3) of the sand bed (10.1) of the sand filter (2) via gravity and thereafter discharges through the sand bed (10.1) of the sand filter (2) under the influence of gravity and vacuum pump (13) assistance at a flux of 8-13 L stream per square meter area of sand bed surface per minute, generating filtrate (15), containing particles of not more than 10 microns in size,
The ultrafiltration sub-station (3) is fed the incoming partially purified pink water stream such that said stream is further purified of large dispersed particles,
The nanofiltration sub-station (4) is fed the incoming majorly purified pink water stream such that said stream is further purified of all dispersed particles and potentially a substantial if not majority of TNT-sized solutes,
The active granular carbon purification sub-station (5) is fed the incoming near-pure stream such that said stream is further purified of all TNT-sized molecules as well as other small reactive molecules via physico-chemical sequestration as opposed to physical segregation, the latter strategy being used by the previous sub-stations.

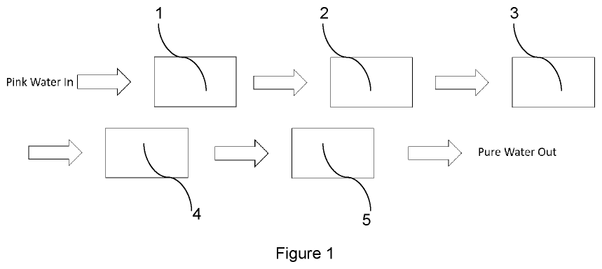

As depicted in the flow diagram of FIG. 1, pink water waste stream enters the flocculation tank (1). TNT flocs sink to the bottom and solids-reduced pink water continues onwards to the sand filter (2). Waste stream filtration by the sand filter (2) yields a further purified, slightly discolored waste stream. For purposes of said invention, said slightly discolored waste stream is designated as filtrate (15). Said filtrate contains TNT particles of less than 10 microns and TNT solutes. While the output stream of subsequently positioned downstream sub-stations are also “filtrates”, these neither correspond to the filtrate (15) of said invention, nor can they be used interchangeably with filtrate (15) for purposes of said invention. Filtrate (15) continues onwards to the neighboring downstream ultrafiltration sub-station (3), which removes the larger of the dispersions and achieves a higher purity filtrate in its output stream. Quite often, said output is a colorless aqueous stream. Said filtrate exits the ultrafiltration sub-station (3) and proceeds to the nanofiltration sub-station (4), which removes all particles and much if not most of the solvated TNT. Filtrate exiting the nanofiltration sub-station (4) finally enters the active granular carbon purification sub-station (5). The highly active granular carbon purification sub-station (5) physico-chemically adsorbs any remaining TNT and other small molecules, which might have evaded the prior separation steps, such that filtrate exiting the active granular carbon purification sub-station (5) is virtually pure of all organics and very likely all inorganics. It is noteworthy that filtrate (15) is directly reusable in various demilitarization processes; the particles dispersed in the filtrate are too small to disrupt the operation of pumps or to plug screen-type filters. For this reason, many military establishments adopting this technology will likely implement the reuse of sand filter filtrate as a normal part of operations. At the other extreme of the spectrum is the very highly purified filtrate obtained from active granular carbon-treated stream, which is suitable for release to the environment and conceivably even suitable for human consumption. The modularity of the invention also imparts the ability to readily utilize ultrafiltered and nanofiltered water grades in any suitable application. These grades will still contain some measure of organics and inorganics.

For comparative purposes, two related in-house works may be cited, which support the merit of said invention. First, a pink water treatment system configured with a 3.5 meter flocculation tank and slightly different sand filter sub-station design was fed the pink water stream under the same conditions as those utilized in the invention. Said alternative treatment system proved robust during operation, resistant to plugging/flow obstruction, cost-effective and highly successful. The success of this system was entirely attributed to the greater vertical length of the flocculation tank, rendering the flocculation process highly efficient. Indeed, the flocculation process served to remove virtually all of the major solids. Since the influx stream entering the sand filter was much cleaner, a filter sheet overlay was neither used nor required along the sand bed. A second difference of the sand filter compared to the invention is that the pink water stream feed pipe opening was flush with sand bed surface as opposed to being suspended a substantial distance above the bed. Like the invention, the modular design of said alternative system also facilitated and enabled the recovery of four grades of water on the basis of selection. Also like the invention, the longevity of the filtration membranes of said system as well as the ready availability of cheap consumables, namely, fine-grain sand and activated granular carbon as filtration media, permitted deployment at any location and remotely located site. The key difference separating invention and said alternative system was the fact that the invention is truly mobile, in that it can be deployed “ready-to-go” in a shipping container. Said established system is also movable, but it is nonetheless classified as “transportable” as opposed to “mobile” in the sense that the system does not arrive ready-to-go, requires transport in sections, consumes more time for set-up/assembly and removal, and demands alternative and potentially stationary housing. Thus from the viewpoint of operational efficiency, said alternative system performs well but suffers from the above inconveniences and logistic constraints.

A second related work specifically housed a pink water treatment system inside a maritime shipping container. Hence, a shorter flocculation tank was utilized. Again, no filter sheet overlay was used and the waste stream feed pipe opening was flush with the sand bed. All operating parameters were identical to the first alternative water treatment system mentioned immediately above. When this second alternative system was tested, the precipitation efficiency of TNT flocs was sub-standard to the extent that a lower proportion of flocs was retained at the bottom of the flocculation tank. Consequently, a higher proportion of larger-sized particulate TNT was retained in suspension. For this reason, stream exiting the flocculation tank was describable as a substantially solids-loaded aqueous suspension as opposed to a sparsely-loaded aqueous dispersion. The decreased performance of the shortened flocculation tank prompted a greater flux of particles transferring downstream of the tank and entering the subsequent sand filter sub-station. Since the sand filter catches all particulate TNT except the smallest of dispersed particles, the atypically high influx of particulate TNT into the filter bed imposed an unexpectedly heavy burden on the sand filter. To compensate for this higher influx of particulate TNT, the bed of the sand filter was frequently maintained. Maintenance typically involved the manual removal of the TNT filter cake, which was deposited over the entire bed. Frequent maintenance also necessitated the occasional replenishment of the topmost sand layer, which over the course of several maintenance repetitions was unavoidably contaminated and debrided to some extent. Maintenance manipulations were trivial and tedious, yet essential to prevent reduced performance. From the viewpoint of operational efficiency, the frequent periodic removal of caked TNT from the sand filter and related maintenance operations introduced an unacceptable inconvenience. This was further exasperated given the work space constraints imposed by the shipping container housing. Ideally, rapid and minimal maintenance was desired in the interest of facilitating overall system operations and providing a mobile system amenable for marketing.

In addressing the need for a truly mobile pink water treatment system, questions naturally arose as to how one might compensate for a poorly performing flocculation tank. A second question, which followed in passing, was whether or not an exceptional sand filter could preclude any need for a flocculation tank. Indeed, in the ideal case that a technical solution could substantially raise the operational performance and convenience of a sand filter, it followed to reason that a mobile treatment system could be offered even without a flocculation tank. Such a technical solution could be particularly useful in cases whereof space economy was top priority.

The discovery of said invention overcame the aforementioned concerns. A surprisingly simple technical solution-irrespective of whether or not a flocculation tank sub-station (1) would partake in the purification system-was to drape a filter sheet (8) along the sand bed (10.1) of the sand filter sub-station (2) and to enforce a centralized and substantial growth of filter cake (16) along the filter sheet (8) using a waste stream feed pipe (6) with an elevated, centrally positioned waste stream feed pipe opening (6.1) to drop waste stream (7) onto the sand bed (10.1). For purposes of the invention, said cake often consists of TNT solids or composite materials thereof. While the passage below will focus on TNT, a person knowledgeable in the field will recognize that said invention may be used to process waste streams containing other suspended materials. Said filter sheet (8) is any suitably porous and chemically inert material, which may optionally be inherently anti-static. The design hence comprises of a sand filter (2) whose sand bed (10.1) is concentrically overlaid by a filter sheet (8) of slightly reduced size compared to the bed, and whose central region (10.1.1) is positioned directly under a waste stream feed pipe opening (6.1), said opening serving to deliver the waste stream (7) onto the filter sheet (8) via the downwards pull of gravity. The vertical separation between pipe opening and sand bed is large, so the gap created between the sand bed and pipe opening permits substantial vertical growth of the filter cake (16). The centrally positioned, overhanging waste stream feed pipe opening (6.1) delivers pink water waste stream (7) primarily to the central region (10.1.1) of the sand bed (10.1), and in so doing, restricts the deposition and accumulation of waste stream solids to within the centralmost region (10.1.3) of the filter sheet (8). Under continual feed conditions (i.e., as more and more solid particles drop out of suspension), the filter cake (16) incrementally grows upwards and outwards. When finished, said filter sheet (8) permits the convenient periodic manual or automated abstraction of the resultant filter cake (16) from the sand bed (10.1). In addition to supporting the growth of the filter cake (16), said filter sheet also supports the radially outwards flow of waste stream (7) along the filter cake (16) and surrounding sheet surfaces. Said radially outwards, lateral flow of waste stream (7), arbitrarily termed surface run-off (7.1), proceeds towards the perimeter region (10.1.5) of the sand bed (10.1) of the sand filter (2). Once there, the surface run-off event is said to have ended. The aqueous flow, now contacting the fine sand surface, descends through several layers of sand (10, 11 and finally 12) to exit the sand filter (2) as a filtrate (15). Only the smallest of particles (10 microns and less, or possibly 5 microns and less) will co-exit and appear in said filtrate (15). Slightly larger, i.e., 10-20 micron-sized TNT particles in the aqueous medium are comparatively rare, as said intermediate-sizes are short-lived once formed, and rapidly agglomerate further in response to physico-chemical effects, attaining readily visible macroscopic sizes. Hence, the brunt of TNT in the initial pink water waste stream will already have formed easily filterable sizes. Said particles are large, dense and able to overwhelm forces attempting to retain them in suspension. Accordingly, said solids will be near-quantitatively deposited along the centralmost region (10.1.3) to yield a filter cake (16). Deposition outside the centralmost region (10.1.3) is relatively rare and occurs as sporadically distributed collections, which are neither sufficiently massive nor sufficiently centrally positioned to qualify as part of the filter cake (16). Intermediate-sized TNT particles, which escape further agglomeration, are generally retained by the sand bed or filter sheet without incident (e.g., plugging), owing to their relative rarity. Again, the smallest aqueous-dispersed TNT particles (i.e., 10 microns and less, or possible 5 microns and less) pass through the filter bed without complications. Should a flocculation tank not partake in the purification train, larger-than-standard TNT fragments might additionally be present in the waste stream (7). The size and distribution of said fragments will depend on the nature of the upstream process (e.g., high pressure aqueous jetting out of artillery shell mother charge explosives will generate some large fragments). These larger-than-standard sized fragments will also deposit along the centralmost region of the filter sheet (8) without incident. When a filtration round is finished, said filter sheet (8) permits the convenient periodic manual or automated abstraction of the resultant filter cake (16) from the sand bed (10.1).

At the initial stages of filtration, the filter sheet (8) also greatly suppresses any surface distortion of the centralmost region (10.1.3). Said region would otherwise be directly subjected to the impact forces of the waste stream (7) falling under the influence of gravity. The protective effect of the filter sheet (8) is thus noteworthy and necessary in the sense that the opening of the waste stream feed pipe is positioned much higher than the typical feed height used in conventional sand filter systems. With filter sheet (8) laid in place, periodic maintenance of the sand bed (10.1) is simplified, facilitated and rather infrequent. In contrast, for standard sand filters, which have no overlaid filter sheet accessory, manual recovery of TNT and tedious filter bed maintenance remain the sole recourse available. The utilization of a filter sheet (8) overlay also implies the possibility of implementing a filter sheet-fitted conveyor belt system to continuously remove filter cake (16) from the sand bed (10.1). For purposes of said invention, periodic maintenance constitutes a very brief operational down-time between continuous periods of operation.

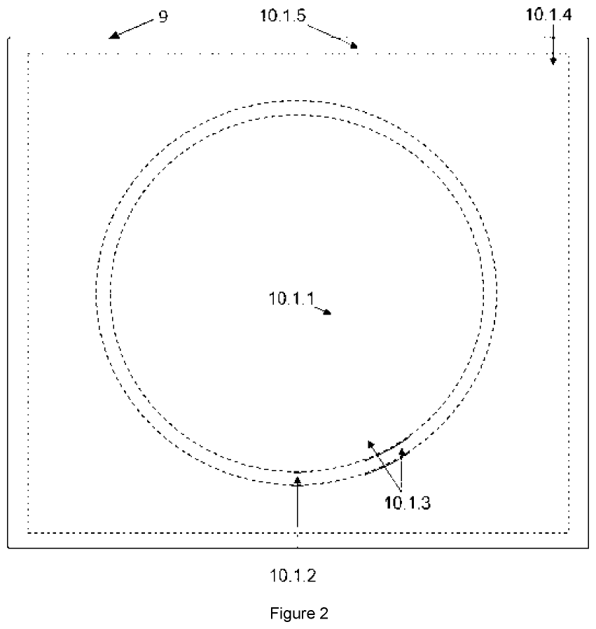

FIG. 2 depicts the top view of the sand bed (10.1), revealing demarcations along the fine sand layer (10). In particular, said perspective depicts the view taken downwards from a central position over the sand bed. Said bed is demarcated into various zones using dashed margins, i.e., the central region (10.1.1), ring region (10.1.2), centralmost region (10.1.3), periphery region (10.1.4) and perimeter region (10.1.5). Once draped over the sand bed, the slightly undersized filter sheet overlay (not shown) covers the entire perimeter region and its enclosed regions. The centralmost region (10.1.3) describes a sheet-covered region above which TNT solids and potentially other filterable solids accumulate, yielding a filter cake (16). In contrast, the periphery region (10.1.4) functions to convey waste stream (7) in all lateral directions as surface run-off (7.1). Part of the stream passes through the filter sheet such that stream entry into sand (7.2) occurs at the periphery region (10.1.4). With a slightly undersized filter sheet (8) in place, the perimeter region (10.1.5) is bare such that the topmost sand layer directly contacts run-off from the waste stream. Hence, the remainder of stream entry into sand (7.2) occurs at the outermost perimeter region (10.1.5). All stream passing into the sand bed eventually exits the sand filter as filtrate (15).

To reiterate, the periphery region (10.1.4) has been described as that sheet-covered domain of sand bed, which encloses the sheet-covered ring region (10.1.2) and extends outwards to the surrounding perimeter region (10.1.5). The perimeter region (10.1.5), originally defined as the only sheet-free, sand-exposed region of the sand bed, draws emphasis to the faster filtration flux experienced within its boundaries compared to the periphery region (10.1.4). As a variant of this convention, an alternative set-up is possible for the sand filter sub-station in which the filter sheet (8) may be oversized compared to the sand bed (10.1). In such cases, the perimeter region (10.1.5) will be covered by sheet. Under such circumstances, the perimeter region (10.1.5) and the more centralized, sheet-covered periphery region (10.1.4) will assume indistinguishable filtration traits. In particular, once covered by an oversized filter sheet (8), filtration traits through the perimeter region (10.1.5) will resemble the through-sheet mode originally established for the more centralized, sheet-overladen periphery region (10.1.4). In other words, in this alternative set-up, waste stream (7) conveyed to the perimeter region (10.1.5) as surface run-off (7.1) will pass through an overlying filter sheet before entering sand making up the perimeter region (10.1.5). A sheet-covered perimeter region thus loses its sand-exposed filtration flux attributes so that filtration through the perimeter region may be regarded as an extension of the process through the periphery region (10.1.4). Given that full sheet coverage carries along a marginal drop in filtration flux, this alternative set-up depicts an apparent digression from the original rationale, which is to maintain rapid discharge. Still, such a full-coverage variant proves particularly maintenance-convenient in cases where particles are highly prone to rapid and hence centralized sedimentation as in the example of streams carrying coarse lumps lacking fines. This alternative set-up may not be suitable to process every waste water stream, especially streams rich in pore-plugging materials, however, there are nonetheless cases showing merit. In comparison, the original set-up, utilizing a slightly undersized filter sheet and exposed sand at the perimeter region, is generally applicable to all waste streams.

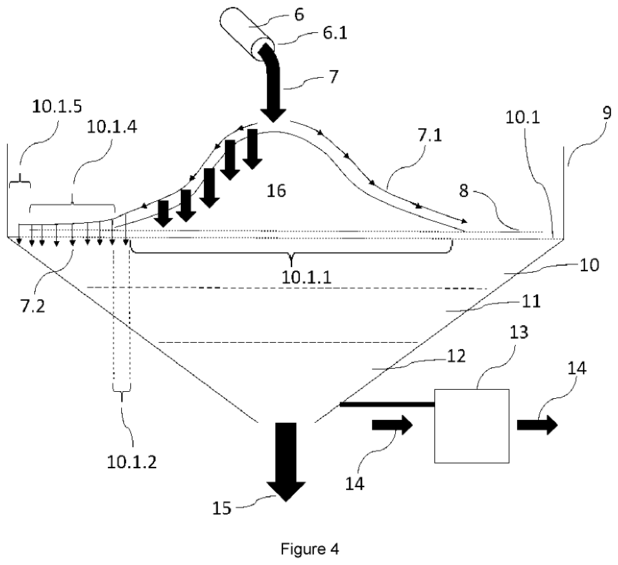

The general approach of the invention, albeit reminiscent of prior art relating to other vacuum-aided sand filter filtration technologies, is distinguishable from the prior art in that (i) the sand bed is not the element utilized to retain solids; the sand bed filters whereas the filter sheet overlay filters and retains solids; (ii) the choice of filter sheet material is highly variable; and (iii) the primary function of the filter sheet-to filter or to retain-at any particular point along the sheet varies according to the proximity of said point to the center of the sand bed; solids are retained nearing the center point, whereas filtration is promoted at the outskirts. Within reasonable bounds, the filtration process is surprisingly indifferent on pore size as well as filter sheet thickness. The reason for this is that in a typical pink water waste stream, suspended TNT particles may be loosely regarded as co-existing as two morphological populations. One population is describable as “hard” and easily filtered. The second is “soft”, and detrimental to continuous pore integrity, ultimately plugging filter sheets irrespective of pore size. These “soft”, sticky TNT contributors are ultimately responsible for the inevitable replacement of the filter sheet (8). For this reason, the approach of the invention differs from the prior art in that emphasis is neither required, nor placed on optimizing the pore size and thickness of the filter sheets or in preventing their plugging, as would be the case for optimized filtration technologies. In the long term, these sticky contributors may even necessitate replacement of a narrow top fraction of the underlying fine sand layer (10). One emphasis of the invention is to exploit the atypically high density of TNT and other energetic organics compared to typical organics. In particular, when the pink water waste stream (7) is dropped from a central and unconventionally high position above the sand bed (10.1), the high deposition propensity of TNT permits the build-up of a substantial, centrally-located filter cake (16). This cake gradually spreads over the course of filtration, but more notably, it substantially resists scattering by forces imposed by the downwards cascading waste stream (7). Overall, the solid particles tend to remain centrally localized along the filter sheet, giving rise to a hill-shaped filter cake (16). Beneath the filter cake and sheet lies a region of the sand bed (10.1), which is termed the centralmost region (10.1.3). The centralmost region (10.1.3) is defined as that sheet-overlaid domain of the sand bed (10.1), which is densely covered by filter cake (16). It follows to reason that as the filter cake grows radially outwards, the surface ascribed as the centralmost region (10.1.3) will by definition radially expand. Since the sand bed area is a constant, the fraction of total surface attributed to the sum of periphery region (10.1.4) and perimeter region (10.1.5) will proportionately diminish to compensate. When a filtration operation is completed (i.e., once the filter cake (16) has reached its maximum practical allowable size), the filter sheet covering the centralmost region (10.1.3) will support a massive cake with a cross-sectional distribution resembling a hill. In keeping with this distribution, said centralmost region (10.1.3) can be demarcated further into two smaller regions, namely, a central region (10.1.1), and a surrounding ring region (10.1.2). Said regions differ in their relative surface area, cake coverage per unit filtration area, and waste stream filtration traits. In any typical filtration round, filter cake (16) will accumulate in substantial amounts along that fraction of filter sheet (8) covering the central region (10.1.1). The predominant accumulation of cake over the central region (10.1.1) causes rapid plugging of filter sheet material overlying the central region. Plugging is so effective that filtration of the waste stream (7) through the central region (10.1.1) quickly becomes negligible. In comparison, that part of filter sheet (8) positioned over the ring region (10.1.2) is less prone to cake deposition. Hence, filter cake (16) accumulates in markedly smaller amounts within the boundaries of the ring region (10.1.2). Within the ring region, the filtration flux of pink water waste stream through the filter sheet yields a graded radial profile. In particular, through-sheet flux increases monotonically in proceeding radially outwards. In terms of filtration dynamics, said ring region thus depicts a transition zone bridging the central and periphery regions (10.1.1 and 10.1.4, respectively) whereof through-sheet filtration slows to a crawl in moving inwards to the central region and speeds considerably in moving outwards of said ring region to the periphery region. Demarcations (perimeter region excepted) are subject to change over the course of a filtration operation. The ring region (10.1.2), which marks the outskirts of the centralmost region, is that area of sand bed commencing at the central region (10.1.1) boundary line and proceeding radially outwards to the centralmost region (10.1.3)-periphery region (10.1.4) border. During filtration, the central region and ring region boundary demarcations shift radially outwards as more and more solids become deposited along the cake. The shift of the outer boundary line of the ring region (i.e., the ring region-periphery region border) follows the advancing edge of the ever-growing filter cake positioned directly above. The shift of the central region demarcation (i.e., the boundary line depicting the ring region-central region border) is more abstract and difficult to define on the basis of visual observation; in all cases, however, the central region demarcation depicts the boundary line at which filtration transcends to a sluggish crawl. Compared to the central region, significantly greater through-sheet filtration occurs along the ring region; however, through-sheet filtration along the ring region is not nearly as rapid as through-sheet filtration occurring within the boundaries of the periphery region, which is relatively free of deposited solids. A second aspect of the invention meriting emphasis is a design trait, which enables rapid discharge of waste stream from the filter bed. Rapid discharge effectively resists, and by enlarge, prevents the accumulation of stream in the filter bed. Highlighted in FIG. 4, the waste stream passively flows radially outwards as surface run-off (7.1) in the direction of high-to-low. Commencing at the waste stream feed pipe (6), the waste stream deposits the brunt of its suspended particles along the centralmost region of the sand bed, affording an ever-growing filter cake. The solids-depleted stream continues past the growing filter cake as surface run-off, crossing into the periphery region (10.1.4). As emphasized in the figure, said surface run-off directly contacts the sheet upon crossing the centralmost region-periphery region border. Surface run-off transcends the four edges of the filter sheet (8) at the outer boundary line of the periphery region to finally arrive at the perimeter region (10.1.5) of the sand bed (10.1). Here, filter sheet is absent and run-off from stream directly contacts sand. In terms of understanding the discharge process, part of the surface run-off (7.1) passes through the filter sheet to the underlying ring (10.1.2) and periphery regions (10.1.4) of the sand bed (10.1), while the remainder of the surface run-off flows over the filter sheet, crossing the sheet edges to arrive at the perimeter region (10.1.5). Regardless of the specific path taken, all flow eventually contacts sand at the fine sand layer (10) and descends through three layers of filtration media to be discharged from the sand filter as a partially purified stream (15). Stream entry into sand (7.2) has been highlighted in FIG. 4 using short thin arrows. The lack of short thin arrows within the central region (10.1.1) reflects the flow-blocking effect of the overlying filter cake (16) and pore-plugging propensity of “muddy” TNT. In particular, when examining the cross-section of a typical, centrally located filter cake, one will generally note a mixture comprised of hard TNT particles dispersed in a TNT mud. The muddy fraction by enlarge concentrates as a thin layer directly overlying the filter sheet surface. Exasperated by vacuum suction, this “sticky mud” rapidly plugs the pores of filter sheet material overlying the centralmost region. Hard and notably larger TNT clumps form the majority of the remaining cake. This size versus spatial distribution of particles within the cake mimics the common finding of large corn flakes at the top of the cereal box and crumbs at the bottom. Plugging of sheet along the central region is inconsequential, as the outskirts of the filter sheet (8), especially material nearest the sheet edge, remain virtually unplugged; as such, said outskirts of filter sheet successfully mediate the passage of surface run-off through the sheet to the underlying periphery region (10.1.4) of the sand bed (10.1). Said outskirts of the filter sheet (8) also convey surface run-off radially outwards to the perimeter region (10.1.5). Here, run-off from the waste stream experiences even more rapid discharge through the exposed sand bed.

The demarcation terminology of the invention was introduced to facilitate the understanding and clarity of regional events relating to the filtration process. In particular, each demarcated region was defined to reflect spatially distinct differences in the overall filtration process. Herein, said demarcation terminology strictly applies to regions of the sand bed (10.1). The boundary lines demarcating the sand bed (10.1) of the invention are all circular, given the use of a single feed pipe. However, an expert in the field will realize that multiple feed pipes should yield different boundary line geometries. The demarcation convention selected herein divides the sand bed into various zones-i.e., the central region (10.1.1), ring region (10.1.2), centralmost region (10.1.3), periphery region (10.1.4) and perimeter region (10.1.5). Said regions were defined by adopting an aerial view (FIG. 2) of the sand bed (10.1). Interestingly, from this perspective, the sand bed and overlying filter sheet are concentric with respect to their center points. Since the filter sheet (8) is draped over the sand bed (10.1), a growing filter cake (16) necessarily accumulates directly on sheet as opposed to bed. Hence, there is no possibility for technical ambiguity in describing the deposition and flow of solids and liquids during the filtration process. While the surface of the sand bed was arbitrarily targeted for demarcation in said invention, one adept in the field will realize that said demarcation convention may be applied instead to the filter sheet overlay. Indeed, making direct reference to specific regions of said filter sheet (8) could potentially simplify the description of events occurring thereon. It follows to reason that the demarcation terminology defined herein for the sand bed may optionally be used interchangeably or entirely extrapolated as a matter of preference to the surface of the overlaid filter sheet (8) without introducing unwanted ambiguity; for instance, those knowledgeable in the field may arbitrarily choose to define the centralmost region as a region along the filter sheet as opposed to the underlying sand bed if they feel such a choice might simplify the description of a filtration process. Said alternative demarcation convention—i.e., demarcating the sheet surface as opposed to the sand bed—might fare well in cases where the sand bed is entirely covered by a larger filter sheet. For the sake of consistency, said alternative demarcation convention has neither been applied to this invention, nor does it appear in the teachings; any use of “demarcation”, “boundary line” and “border” terms herein specifically make reference to the sand bed. Lastly, those adept to the field may alternatively choose to explain the same filtration process using appropriate descriptions without resorting to the above demarcation terminology or perhaps they could implement an entirely different demarcation system.

The invention operated effectively when the filter sheet-to-sand bed size ratio, waste stream drop height, h, and waste stream feed rate parameters lay within a specific range of values. A complex performance interrelation of said parameters was confirmed in the sense that satisfactory operation was noted when parameter values lay within a specific range relative to one another. Within this range of relative proportions, prolonged operation and high loadings of filter cake were realized before the filter bed became fully loaded (i.e., saturated) with solids. In said trials, TNT deposition was notably substantial and periodic maintenance was infrequent, attesting to the merit of the approach. At the end of each filtration operation, said filter cake (16) was isolated by means of removing the filter sheet (8) and tilting said cake off the filter sheet (8). Such operations were always performed while the cake was wet. The cake was in turn transferred into an antistatic container or other suitable item for storage. Hence, the process of conveniently recovering a large volume of solid TNT as a hill-shaped filter cake was confirmed, as was the prospect of utilizing said sand filter sub-station in a mobile pink water purification system. When said three parameters were set to values lying outside a specific range of proportions, however, a marked, non-intuitive drop of performance was noted. The bed of the sand filter (2) became prematurely saturated at unacceptably and surprisingly small loadings of TNT. Filtration operations were prematurely ended at the point of saturation to prevent stream accumulation and flooding. The performance drop also necessitated an impractically frequent maintenance schedule to remove the filter cake. Sand filter performance was by enlarge determined by three factors. The first was the relative area of the filter sheet (8) compared to the sand bed (10.1). The second was the flow rate of the incoming waste stream (7) compared to sand bed (10.1) area. The last was the distance, h, between sand bed and waste stream feed pipe opening (6.1) compared to the area of the sheet. For any given flow rate, the ideal waste stream drop height, h, is small enough to minimize the scattering of previously deposited solids yet large enough to provide sufficient space for vertical growth and formation of a substantial TNT cake. Sand filter performance was also potentially related to (i) the free-running capacity of the vacuum pump (13) used to facilitate flow through the sand bed, (ii) the porosity (i.e., the total void volume fraction) and permeability (i.e., stream flow-through speed, reflecting the size, shapes, and juxtapositioning of sand particles) of media making up the fine sand layer (10) as well as the porosity (i.e., the total pore volume fraction) and permeability (i.e., stream flow-through rate) of the filter sheet (8). All possibilities were assessed. Amongst these, the vacuum pump capacity, sand layer porosity and sand layer permeability are intrinsically large. In other words, the vacuum pump (13) is sufficiently strong and the fine sand layer (10) is sufficiently leaky so as to not impose any bottle-neck effect on the overall discharge process. A rate-limiting contribution of the vacuum pump may thus be ruled out assuming that all sand filter systems will utilize a vacuum pump or system with a proportionately high free-running flow capacity relative to the size of the bed of the sand filter. Likewise, any potential contribution of the sand layer on filtration rate may be ruled out, as the sand bed proved sufficiently porous and permeable so as to permit much higher flux values compared to the overlaid filter sheet.

The effective porosity and permeability of the filter sheet signified the bottle-neck of the discharge process. The term “effective porosity and permeability” has been coined herein to signify the weight-averaged influence of many physico-chemical parameters underlying the passage of stream through sheet. Interestingly, this bottle-neck effect on filtration flux proved highly reproducible. In testing a diverse range of filter sheets, flow rate variations were not readily apparent. Flux through various sheet types proved nearly constant, irrespective of weave structure, material selection, and thickness. As these sheets behaved similarly under the given laboratory test conditions, intrinsic differences potentially affecting flux were hard to discern. The assessment proved even more challenging when applied to the sand filter sub-station. Detracting even more from the ability to empirically distinguish filtration rate differences among filter sheet types was the discharge contribution of the undraped, sand-exposed surrounding perimeter region. Since flux through the perimeter region predominates the discharge process, potential flux variations over a large series of different filter sheets becomes virtually undetectable.

The invention extends filtration times, shortens down times for maintenance, permits easy removal of filter cake, and allows for exceptionally low upkeep of the sand bed. Hence, the combined strategy of sand bed, filter sheet, and focused stream delivery from a drop height, h, depicts a convenient strategy to boost the performance (i.e., capacity and purity) of any waste water treatment system, which either lacks a flocculation tank or suffers from a sub-optimally performing one. Still, the potential contributions of bed, sheet and directed stream delivery must be appropriately tuned for their combined effect to be beneficial and deemed practical. For this reason, strict adherence to the operating boundary conditions are paramount. Each filtration operation and subsequent maintenance operation qualifies as one round. A typical work day/shift entails a series of continually repeated rounds. A substantial filter cake is obtained in each round provided that operating parameter values are set within certain boundary conditions. The net effect of adhering to said boundary conditions is to maximize the time devoted to filtration as well as to minimize any down time utilized for maintenance over the course of a work shift. It should be emphasized that the work shift maintenance frequency also drops. As a rule of thumb:
The filter sheet (8) and bed of the sand filter are preferably identically shaped (i.e., when viewed from above). The filter sheet is slightly smaller than the underlying sand bed of the sand filter (2) such that when overlaid, the filter sheet (8) covers approximately 92-97% of said sand bed (10.1). The filter sheet is appropriately draped over the sand bed such that ideally the center points of filter sheet and sand bed overlap. Additionally, the filter sheet is draped along the sand bed such that the edges of the filter sheet and perimeter walls of the sand filter delineate an unbroken, symmetrically-shaped perimeter region over the surface of the sand bed. As the perimeter region lacks filter sheet coverage, surface run-off from the waste stream can readily contact sand making up the perimeter region. The perimeter region thus promotes rapid and unimpeded entry of surface run-off into the sand bed as well as stream descent through the underlying sand layers. More complete sand bed coverage (i.e., >97%) by filter sheet detracts from the discharge rate and filtration capacity. Lesser coverage using a smaller-than-ideal filter sheet (i.e., <92%) reduces the maximum attainable cake size and increases the maintenance frequency;
The flow rate of the waste stream (7) should be large enough to satisfy acceptable hourly purification requirements, but not large enough to (i) overwhelm the filtration dynamics of the sand filter (2), or (ii) skew the filter cake cross-sectional profile from the ideal hill shape. In our experience, a feed rate yielding a flux through the sand bed of between 8-13 liters per minute per square meter of sand bed proved ideal. Optionally, as the filter cake grows, the feed rate may be slightly lowered to control stream accumulation in the bed. It should be emphasized that said flux values were calculated by dividing the feed rate by the total sand bed surface. Said flux range is thus a surface-averaged result, which neither reflects the true flow dynamics along the cross-section of the sand bed, nor does it distinguish between regions experiencing low as well as high filtration fluxes. For example, high flux within the perimeter region and negligible flux at the center of the sand bed should be noted. Still, said empirically-arrived flux range of 8-13L/min.m² provides a good reference point to proceed. Lower flux values lead to unnecessarily long processing times and detract from the overall system capacity. Higher flux values prompt a dramatically greater maintenance frequency, which is not offset by the amount of filter cake collected during that round. The choice to define stream flow in terms of a flux range was made in view that flux is independent of system scaling;

The waste stream drop height, h, of the pink water waste stream (7) ideally ranges from ¼ to ⅓ of the edge length of the filter sheet (8). Positioning the feed pipe opening closer to the filter bed limits the maximum height of the growing TNT cake, whereas positioning the feed pipe above this ideal range intensifies stream impact forces, substantially scattering particles already deposited below in the growing cake. In principle, the separation distance between the waste stream feed pipe (6) opening and the sand bed can be gradually increased over the course of filtration operations. The underlying rationale is to avoid excessive scattering during the early stages of filtration and to allow the buildup of an optimally large filter cake during the end stages. In practice, however, the improvement noted in the final form and size of the filter cake did not justify the routine implementation of this additional measure.

The above argument and findings apply to the design of a filter sheet (8) and sand filter (2) of square geometry. An expert in the field will appreciate the revisions needed to extend said invention to other geometries. For non-square filter sheets such as a circle, the term dimension refers to diameter. For rectangular filter sheets, the term dimension refers to the average of length and width unless the aspect ratio is >1.5, in which case the shorter dimension (i.e. width) applies. Similar arguments can be extended to all polygonal shapes. Terms used herein such as “radially outwards”, “radially inwards”, “radially along”, “radially towards”, etc., are not necessarily limited to the treatment of circular shapes and may be extended to squares as well as other potential sand bed (10.1) and filter sheet (8) geometries provided that the filtration dynamics bear elements of circular symmetry. An expert in the field will know that a sand filter will function adequately even if the opening of the waste stream feed pipe (6) is off-set from the center point of the sand bed (10.1). In practice, however, filter cake growth is best with a centrally positioned pipe opening. An expert in the field will also recognize that waste stream can be delivered to a high aspect ratio sand bed via multiple, suitably-aligned feed pipe openings or any related apparatus.

Events underlying the above findings may be better understood by noting the sand filter (2) and filter sheet (8) schematics portrayed in FIGS. 2-6. Amongst the many details, the inorganic filtration media comprises of a top layer (10) of approximately 0.4-0.8 mm sized sand particles, an intermediate depth layer (11) of approximately 1-4 mm sized sand particles and a bottom layer (12) of approximately 3.5-8 mm sized gravel particles. While other inert ceramic filtration media (e.g., perlite, feldspar, etc.) or alternatively reactive organic media (e.g., granulated active carbon) can be used, sand and gravel are typically the media of choice for reasons of low cost, ready availability of differing sieve sizes, and good performance. Unconventional alternatives such as sufficiently incompressible and non-swelling organic and biological materials, appropriately crushed/ground, may also be used. Examples may include aquatic shells, mollusk shells, nut shells, bark, coarse wood chips, and various plant seed-bearing hard organs (e.g. pine cones). The filter sheet (8) is describable as a porous/leaky overlay (porosity preferably 0.9 or greater) with pore sizes typically ranging from 50-100 microns. As pores can range from being easily wettable at one extreme to non-wetting at the other, and perfectly circular at one extreme to resembling long, narrow slits at the other, the apparent optimum pore size range mentioned above reflects a general rule of thumb, which is subject to some weight-averaged variability on the basis of the material wetting traits, pore shape, overall pore abundence (i.e., porosity), and sheet thickness as well as less obvious permeability factors such as pore accessibility and interconnectivity. Hence, an expert in the field may chose to revise the pore size range of a filtration overlay (preferably without compromising effective porosity and permeability) to better reflect the intrinsic traits of the chosen material. Ideally, the filter sheet (8) is a chemically inert and optionally anti-static material comprising of either a textile cloth, a porous polymeric filtration membrane, a fine-mesh screen, a cellulose filter paper, or a non-woven fabric, the lattermost two optionally supported by a reinforcing backing made out of an inert metallic, ceramic or plastic coarse-mesh screen. Herein, “chemically inert” denotes the high resistance of the filter sheet material towards chemical modification or impregnation/absorption by TNT and related energetic materials. Fibers making up said textile cloth may be any conventional natural or synthetic textile fiber or combination thereof including cotton, flax, hemp, wool, yarn, polyester, polyamide, polyimide, polyolefin or chlorinated polyolefins. Fibers making up said textile cloth may also comprise of other fibers suitable for weaving into a cloth such as certain glass and ceramic fibers. Similar porosity and pore size traits may also be utilized in filter sheets (8) comprising of paper/cellulosic or conventional non-woven materials, said cellulosic material being held together primarily by weak hydrogen bonding while said non-woven material relies on covalent bonding, thermal bonding and/or mechanical entanglement of synthetic fibers. Said synthetic fibers comprise of typically-used fibers of the plastics industry as well as non-coventional fibers potentially suitable for non-woven processing such as polyvinyl chloride. In utilizing filter sheets (8) comprising of paper/cellulosic or non-woven sheet materials, an optional reinforcing coarse mesh backing comprising of a chemically inert metal, ceramic or polymeric screen will provide additional mechanical strength, which may be needed to more easily remove the loaded filter sheet and overlying TNT cake. Here, “coarse” denotes a mesh size/number sufficiently small so as to permit easy gravity filtration of fluid through the overlay. “Coarse” does not entail a mesh size/number small enough to prompt straining, as would be the case of a coarse mesh mosquito net arrangement. The filter sheet (8) may also be a porous polymeric membrane comprising of polyethylene, polypropylene, polyethylene teraphthalate, nylon, cotton, Teflon, polyvinyl chloride, polybutylene teraphthalate, polyester, polyamide, polyolefin or any combination of said materials as well as other conventional materials used by the filter press industry. Finally, said filter sheet may be an ultra-fine mesh screen comprising of chemically inert metal, plastic or glass fibers.

The filter sheet (8) chosen may also bear inherent anti-static traits or contain fillers or additives to impart anti-static traits, albeit, water will serve as a suitable electrical conductor. Still, care must be taken to prevent the inadvertent drying of residual energetic materials clinging along the filter sheet especially if anti-static traits are overlooked in selecting the filter sheet material.

It is alternatively possible to implement full filter sheet coverage of the sand bed (10.1). With the perimeter region being draped by filter sheet in this alternative arrangement, the overall rate of discharge of filtrate (15) becomes marginally and acceptably reduced. Said alternative approach is especially applicable using filter sheets with pore sizes lying within the higher spectrum of the recommended pore size range. Indeed, approximate 90-100 micron pore-sized sheets heighten flux through the periphery and ring regions, thereby substantially compensating for flux reductions along the perimeter region. As a noteable benefit, this arrangement protects the topmost fine sand layer of the perimeter region against eventual fouling by preventing sporadic deposition of residual solids suspended in the surface run-off. Hence, an oversized filter sheet arrangement further extends the useful lifetime of said sand layer. To implement said alternative set-up, an oversized filter sheet (8) is overlaid along the sand bed (10.1) as opposed to a slightly undersized filter sheet (8). The oversized sheet (8) is configured such that sheet covering the centralmost region (10.1.3) of the sand bed (10.1) serves as the site for waste stream delivery and buildup of a filter cake (16), whereas sheet surrounding the central region (10.1.1), namely, sheet along the ring, periphery and perimeter regions mediates the through-sheet descent of stream to the underlying sand bed (10.1) as well as the radially outwards flow of stream along the sheet as surface run-off. Process conditions are such that through-sheet flux increases in radially digressing outwards from the central region to the perimeter wall of the sand filter (2). In contrast, solids deposition along the sheet correspondingly decreases in radially digressing outwards from the central region. Unlike the slightly undersized filter sheet set-up of the invention, stream cannot bypass a larger filter sheet because there are no filter sheet edges positioned within the sand bed. Since stream must pass through the sheet before contacting the underlying sand layer, the filtrate discharge traits of this alternative set-up more noticeably reflect the traits of the filter sheet (8). While flow problems were not encountered in testing the filtration process, an expert in the field will recognize the need to choose an appropriate filter sheet more diligently compared to the approach utilizing a slightly undersized filter sheet. An expert in the field will likely restrict said alternative approach to the treatment of waste water streams containing a very limited fraction of pore blockers (i.e. “muddy” fines of TNT and otherwise).

With an undersized or oversized filter sheet draped along the sand bed, the rate at which filtration proceeds at any particular point along the sheet reflects the coverage of the filter sheet by filtered solids at that particular point. When generalized over the entirety of the sheet, a solids coverage versus radial distance correlation and a related filtration flux versus radial distance correlation is noted. In digressing incrementally away from the central region of the filter sheet (8) towards the periphery of the sand filter (2), the filter sheet experiences an ever decreasing localized coverage by filtered solids (e.g., TNT particles) and a corresponding increase of through-sheet filtration flux at that same region. Stated more systematically, waste stream passes through the filter sheet (8) to the sand making up the underlying bed of the sand filter (2). Said passage of stream occurs at regions of filter sheet (8) positioned outside the central region of the filter sheet (8). Again, said central region describes a region of the sand bed whereof a filter cake accumulates upon the overlaid filter sheet (8) in substantial amounts such that through-sheet filtration within that region is consequently slow to nil. Slightly better through-sheet filtration occurs within a thin ring region just surrounding the central region, where much less of the cake is deposited. The highest filtration fluxes are experienced outwards of said ring region in two regions defined as the periphery and perimeter regions. Among these two, the perimeter region experiences the higher filtration flux irrespective of whether or not the periphery region is sand-exposed or draped by filter sheet.

In cases of full sand bed coverage by an oversized filter sheet, the high-flux discharge advantages of a readily-accessible, sand-exposed perimeter region will be lost. Given this fact, the possibility to experience and even possibly prompt solids buildup along the entirety of the filter sheet may concern those less versed in the art. Thankfully, the correlations noted in the previous paragraph clearly indicate that solids deposition and stream flow are spatially influenced, with only the central region of the sand bed becoming plugged. Properly operated, trial runs confirmed that substantial sheet coverage was neither encountered, nor did the occasional scattering of particles establish an obstructing barrier opposing easy filtration. Sheet covering the outermost surface of the perimeter region displayed the lowest buildup of filtered solids. Said buildup was gradual, sporadic at best, and small enough to be deemed insignificant. Filtered solids became more visible in proceeding inwards across the perimeter and periphery regions, albeit, said accumulation was still sporadic and inadequate to hamper filtration. Taking the center of the filter sheet as the origin, an inverse radial distance versus solids deposition proportionality trend was noted, paralleling the relationship noted with the slightly undersized filter sheet set-up. Similarly, through-sheet stream flux progressively increased in digressing radially outwards to regions with less solids deposition. Assuming that particle buildup, pore integrity and permeability are related, one may also surmise from the above trends that the surface of the filter sheet retains more & more pore integrity in incrementally progressing away from the center. To reiterate, a completely draped sand bed can be operated such that sheet covering the centralmost region of the sand bed serves as the site for the buildup of a filter cake, whereas sheet lying outside the central region, namely, sheet along the periphery and perimeter regions of the sand bed mediates the passage of stream through the sheet to the underlying sand bed. Through-sheet filtration flux increases in radially digressing outwards from the center to the perimeter wall of the sand bed, whereas solids deposition along the sheet correspondingly decreases in radially digressing outwards from the center.

The above treatment rationalizes how a sand filter fitted with an oversized filter sheet experiences progressively higher localized through-sheet filtration fluxes in digressing from the inner boundary of the ring region towards outward locations terminating at the perimeter wall. Said rationale is again valid for a sand filter overlaid with a slightly undersized filter sheet. However, this time the exposed and readily accessible sand bed contribution of the perimeter region is so dominant in mediating stream discharge from the sand filter that any through-sheet contribution becomes secondary. Simply put, incremental flux changes along the sheet still exist, but their contributions are difficult to assess or quantify with respect to the overall filtration event. The flux contribution of the perimeter region on the overall discharge process thus fundamentally differs in comparing the oversized and slightly undersized filter scenarios, the latter set-up featuring an exposed sand bed. The undersized sheet scenario is advantageous compared to the oversized scenario in that the filtration process is marginally faster and generally less prone to the possibility and potential drawbacks of filter sheet plugging. That being said, the retention of pore integrity is highly dependent on the nature of the waste stream. Over the course of a work shift, pore plugging can vary from inconsequential to catastrophic. Accordingly, an expert in the field will adjust the filter sheet (slightly undersized versus oversized), filter sheet material, and filtration conditions of the sand filter sub-station to optimally comply with the nature of a particular waste stream.

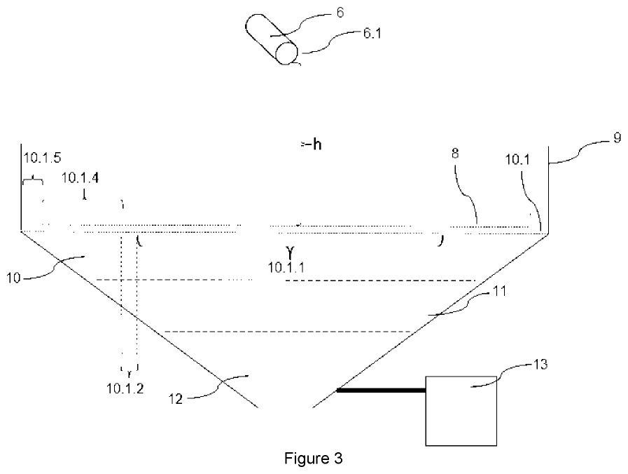

FIG. 3 illustrates the cross-section of an idle sand filter (2) sub-station. Shown is the sand bed (10.1), which is enclosed by the perimeter wall (9) and overlaid by a filter sheet (8) of a slightly smaller size compared to the sand bed (here, “size” reflecting surface area). Said sand bed (10.1) is a flat surface defining the top of the fine sand layer (10). Beneath the fine sand layer is a coarse sand layer (11) and thereunder is a fine gravel layer (12). All three layers of filtration media are arranged inside the body of the sand filter (2). Said three layers are horizontally stacked so as to completely fill the body of the sand filter. Attached via a conduit is a vacuum pump assembly (13). Suspended above the center of the sand bed is the open end/opening of a waste stream feed pipe (6). A waste stream drop height (i.e., meaning separation) between the waste stream feed pipe opening (6.1) and sand bed has been labeled “h”. For clarity, the distinction between sand bed, filter sheet (8), and the perimeter (10.1.5), periphery (10.1.4), ring (10.1.2) and central (10.1.1) regions of the sand bed (10.1) have been emphasized using arrows and numbering. The sand filter body is V-shaped so as to effectively direct all filtrate (15, not shown) to a central discharge location at the bottom. For square and rectangular filter bed geometries, the V-shaped body profile can be engineered along one direction as implied by the cross-sectional drawing, or extended to both dimensions to yield an inverted tetrahedral pyramid (not shown). In practice, the former design is easier built and performs well. An inverted conical body shape is also an alternative and yields a circular sand bed. However, conical geometries are more difficult to engineer and do not maximize the use of available space in a room.

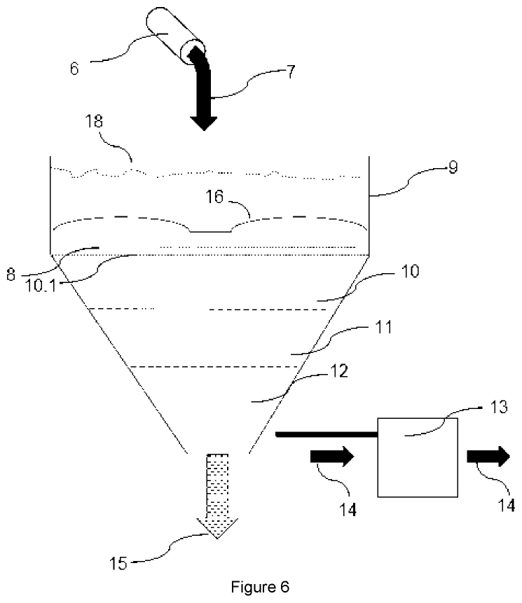

FIGS. 4-6 illustrate the cross-sectional profile of an operational sand filter (2). In this treatment, the incoming waste stream flow rate and waste stream drop height, h, is adjusted to a fixed value. The waste stream (7) is delivered from above via the open end of the waste feed pipe (7) and discharged at the bottom of the sand filter as a filtrate (15), which is partially purified. The filter cake accumulates more and more particles over the course of the filtration operation and grows accordingly. The size of the sand bed (10.1) and overlying filter sheet (8) progressively and proportionately decreases in proceeding from FIG. 4 through to FIG. 6. An alternative comparison (not shown) would be to fix the sand bed (10.1) and overlaid filter sheet (8) sizes, and to gradually increase the waste stream feed rate. The former treatment was chosen herein, as size variations are easier to illustrate compared to flow rates.

FIG. 4 illustrates the cross-section of an operational sand filter (2) utilizing a slightly smaller filter sheet compared to sand bed. Apart from the elements emphasized in FIG. 3, herein the waste stream (7), the surface run-off (7.1), stream entry into sand (7.2), air flow (14), discharge of filtrate (15), and positioning and hill-like shape of the growing filter cake (16) may also be noted. The incoming waste stream (7) is fed to the sand bed via an open-ended feed pipe (6), which hangs above the sand filter (2). The waste water feed pipe opening (6.1) is positioned a certain drop distance, h, directly above the center point of the bed of the sand filter (2). The stream is portrayed as falling onto the central region (10.1.1) of the sand filter (2) but it may occasionally also fall on the ring region (10.1.2). Dense particles (e.g. TNT) deposit and accumulate primarily along that part of sheet directly above the centralmost region (10.1.3, not labelled) of the sand bed (10.1), said centralmost region being the sum of the central (10.1.1) and ring (10.1.2) regions. The filter cake (16) shown in FIG. 4 is neither instantly produced, nor do its features occur by chance. During filtration, solid particles suspended in the waste stream continuously fall out of suspension. These become deposited along the filter sheet as they settle out. The sand filter design encourages centralized deposition and accumulation along the bed. It follows that a centrally enforced, focused accumulation of particles prompts a gradual upwards and outwards buildup of a filter cake. Overall, the filtration process yields a cake bearing a cross-sectional profile reminiscent of a normal distribution curve (i.e., a hill). Said cake continues to grow upwards and outwards for as long as the filtration process is allowed to continue. As implied by the cross-sectional profile, most deposition occurs at the center whereas less and less deposition is noted in radially digressing away from the center. In having deposited a very large fraction of solids over the centralmost region, the solids-reduced waste stream comprises primarily of small particles (e.g. TNT) and solutes (e.g. TNT). Said solids-reduced waste stream, which has been dubbed as surface run-off (7.1) and graphically portrayed as long thin lines with multiple arrowheads, flows radially along the existent filter cake (16) and filter sheet (8) towards the periphery (10.1.4) and finally perimeter (10.1.5) regions. In time, some particles (ideally a tiny mass fraction compared to the central filter cake) will sporadically deposit (not illustrated) along the periphery and possibly perimeter regions of the sand bed (10.1). Amongst these particles, those reaching the sand-exposed perimeter region will be retained by the fine sand layer excepting the tiniest of micron sized solids. Particles sporadically deposited more centrally within the periphery region will be retained by that area of filter sheet (8), which overlies the periphery region. Along the perimeter region, periphery region, and to a lesser extent the ring region, the solids-reduced stream is portrayed in the figure as passing into the sand bed. Stream entry into sand (7.2, short thin arrows) is most predominant nearing the sand filter perimeter wall (9). At the bottom of the sand filter, the finest particle dispersions are discharged from the sand filter (2) as filtrate (15). The size of particles exiting the sand filter (2) are generally not larger than 10 microns but can be as small as 5 microns or possibly even less in very rare instances.

As implied by FIG. 4 and the teachings, the invention prolongs filtration operations long enough to obtain an abnormally large mass of filter cake. Prolonged filtration operations and a large mass yield signify a high capacity process with the convenience of infrequent maintenance interventions and short down times. Herein, maintenance primarily involves the physical removal of the TNT cake. However, at times maintenance may also include replacement of the filter sheet (8). In rare instances, corrective reshaping of the sand bed and/or replacement of some of the underlying filtration media might also apply. To retain an acceptable level of practicality, the cross-sectional profile of the filter cake should very roughly resemble a normal (i.e., Gaussian) distribution (as shown). Over the course of cake formation, a solids-reduced waste stream navigates from the centralmost region of the bed to the periphery and lastly perimeter regions as surface run-off (7.1). Vacuum pump (13)-aided discharge of surface run-off from the sand filter is both rapid and unimpeded, for lack of plugging. Lack of plugging, particularly along the sand-exposed perimeter region but also the sheet-covered periphery region to a lesser extent, is a key attribute, which prevents the accumulation of stream within the sand bed. Lack of stream accumulation, in turn, prevents undesirable reshaping of the incrementally-growing filter cake. This favorable situation permits extending the filtration operation to the point that a very substantial filter cake is obtained before maintenance becomes mandatory. In contrast to the periphery region, the central region of the filter sheet-by now quantitatively plugged-merely serves to support the incremental outwards and upwards growth of the cake. Cake growth can be allowed to continue for as long as the sand bed retains a sufficiently large, freely filtering surface and discharge rate. Beyond a certain size of filter cake, i.e., once the cake has grown outwards to the point that the periphery region diminishes and filtration rate limitations approach problematic levels, the sand bed is said to have become “saturated” by the sheer bulk of the cake. At this point, the sand bed will require maintenance in order to continue operations. Proceeding beyond saturation results in stream flooding of the bed as well as cross-contamination of sand and filter cake. In very large sand filter systems, filtration could conceivably be terminated even before the point of saturation is reached if removal and subsequent handling of the filter cake becomes a concern. Unlike outwards cake growth, vertical cake growth can neither alter the available periphery region, nor saturate the sand bed. For this reason, conditions promoting upwards cake growth are encouraged. An expert in the field will know to balance and consider other factors too, including the stream feed rate.

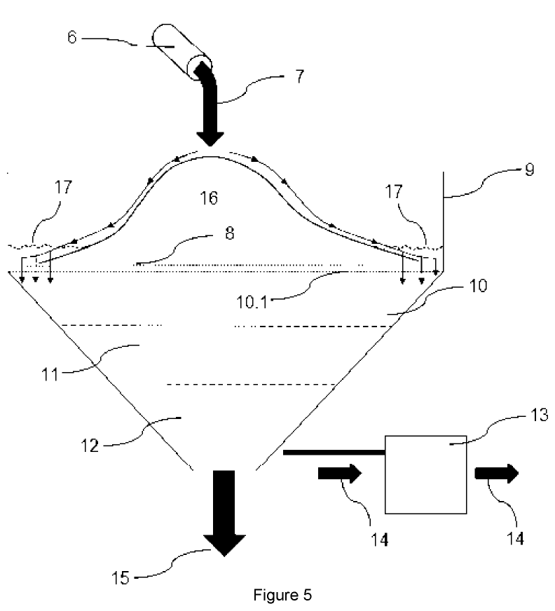

To reiterate and highlight, FIG. 4 depicts a cross-sectional illustration of a filter sheet-integrated sand filter sub-station (2) operating under vacuum assistance. Centrally positioned along the filter sheet is the growing filter cake (16). Said filter cake depicts an ensemble or accumulation of individually deposited solids separating out of suspension in a central, predetermined area. Said cake gradually grows upwards and outwards as more and more particulate solids deposit thereon (thick arrows on cake). The resultant solids-reduced stream flows radially outwards as surface run-off (long thin lines with multiple arrows) to the periphery and perimeter regions, and within these regions stream enters the sand bed (small thin arrows) by first transcending the overlaid filter sheet (8) or by directly contacting exposed sand making up the perimeter region. Filter sheet (8) immediately beneath the growing filter cake serves no significant filtration role, as it is predominantly plugged. Over time, outwards cake growth expands the centralmost region and correspondingly diminishes the surrounding periphery region of the sand bed. Growth is allowed to continue until filter cake extraction becomes mandatory, signaling the onset of maintenance. FIG. 5 portrays a filtration process utilizing a sand filter (2) with a smaller sand bed and the same stream influx rate. In the scenario shown, the surface available for filtration is still sufficiently large enough to permit rapid entry of the stream into the sand filter bed. Again, a normal distribution-like buildup of centrally located cake is obtained. Compared to FIG. 3, however, the illustration additionally suggests an encroaching limit to the filtration operation in the sense that one can note stream accumulation along the sand bed (17), presumably before its descent into the sand bed. This mild stream buildup portrayal actually depicts the most efficient use of work space, as the filter bed size is less than FIG. 4, and yet a large filter cake is still formed prior to periodic maintenance. While not explicitly illustrated, the cross-sectional profile portrayed in FIG. 5 (i.e., emphasizing a mild stream buildup in the bed) would also apply to a sand filter of the same size as that shown in FIG. 4 operating at a higher stream influx rate.

Assessed more technically, FIG. 5 is a cross-sectional illustration of a sand filter (2) performing near the boundary limits of failure, albeit successfully. In keeping with this scenario, the sand bed area is less than the bed portrayed in FIG. 4, whereas the incoming stream flux is equal to that of FIG. 4. The centrally located filter cake gradually grows upwards and outwards as more and more particulate solids accumulate and deposit thereon. Just like in FIG. 4, the solids-reduced stream flows radially outwards, crossing the outskirts of the filter sheet. Said stream enters the sand bed either by transcending the filter sheet or by directly contacting exposed sand (small thin arrows) along the bed perimeter. This time, however, the effective (i.e., available) filtration area is less compared to the scenario depicted in FIG. 4. Consequently, filtration is not fast enough to instantly channel the stream through the sand bed. As a result, a small but manageable “steady-state” stream accumulation along the sand bed (17) is noted, as illustrated by wavy dotted lines. The operating conditions portrayed herein yield the maximum cake loading per unit filtration area. Still, operating the sand filter near its discharge limits carries along added risks in the sense that any subtle unanticipated surge of flow in the incoming feed stream or drop of available filtration area could quickly result in the system being overwhelmed.

FIG. 6 portrays a filtration operation attempted utilizing an even smaller-sized sand bed. Again, the same stream influx rate is applied in this treatment. The filtration process performs poorly in this example because stream collects in the sand bed as opposed to readily descending beneath. Given the momentum, turbulence and buoyancy effect of the accumulated stream, solid particles are subjected to substantial transport forces and are thus unable to assume a hill-shaped profile. “Sticky” components (e.g. “muddy” TNT particles), now freely dispersed over all points of the sand bed, begin to plug and thus impede filtration. Before long, a flat filter cake (16), with a plateau-like cross-section, is obtained. The sand bed and filter sheet quickly become fully covered by aggregated particles in this situation, and as might be surmised, their surfaces will be substantially plugged by sticky components. The flow of filtrate (15) will diminish substantially and unexpectedly abruptly, necessitating very frequent periodic maintenance (sheet and sand replacement inclusive) in order to mitigate stream flooding of the sand bed (18) and to prevent stream spill-over containing energetic materials to the outside of the sand filter (2). The drop in discharge rate is portrayed in FIG. 6 using a dotted arrow to depict the filtrate (15) as opposed to a solid arrow, which was used in the case in FIGS. 4 and 5. In addition to requiring frequent periodic maintenance, the overall mass of cake collected per unit sand bed area for a given time will also be small compared to what it would have been had the growing cake retained a hill-like cross-sectional distribution profile. While not explicitly illustrated, the sketch portrayed in FIG. 6 also applies to a filter bed of the same size as that shown in FIG. 4 but with a grossly exaggerated stream influx rate.

Assessed more technically, FIG. 6 is the cross-sectional illustration of a sand filter (2) after experiencing performance failure. In this scenario, the sand bed is portrayed as being smaller than that of FIG. 5, whereas the incoming stream flux is equivalent to that portrayed in FIGS. 4 and 5. With not enough filtration area available to rapidly convey the stream downwards through the sand filter (2), the sand bed is quickly overwhelmed by stream flooding of the sand bed (18, wavy dotted line). The turbulence and buoyancy effect of the pooled stream serves to redistribute, for instance, hard and “muddy” TNT particles throughout the sand bed, yielding a shallow, plateau-like cross-sectional profile as opposed to the desired normal-distribution-like profile of the previous examples. As the entire filter surface becomes plugged by “muddy” TNT, the filtration unit experiences failure, and requires premature maintenance to prevent stream spillage outside of the sand filter bed. It follows to conclude that very frequent maintenance would be needed to continue operating the unit under these particular constraints.

On a more general note, scenarios portrayed in FIGS. 4 and 5 may also represent a continuum of the same filtration operation, with FIG. 4 depicting the early stages and FIG. 5 depicting the final stages before maintenance. In other words, FIG. 5 can be perceived as depicting the “extended use” scenario portrayed in FIG. 4, with the understanding that the filter cake has grown outwards to the point that stream flow into the sand bed has become sluggish. Said extended use scenario will again be accompanied by a subtle, steady-state accumulation of stream just above the sand bed. In contrast to FIGS. 4 and 5, FIG. 6 would not accurately depict the inadvertently-arrived “post-saturation” scenario of the filtration operation because a much larger cake would already have accumulated compared to what is portrayed in FIG. 6. Indeed, the failure scenario depicted in FIG. 6 stems entirely from the improper selection of operating parameters at the start of operations (e.g., excessive feed rate). In other words, the failure mode portrayed in FIG. 6 is not due to an on-the-fly operator error such as inadvertently extending the filtration activity to a time point beyond when the operation should have been terminated and periodic maintenance should have been implemented.

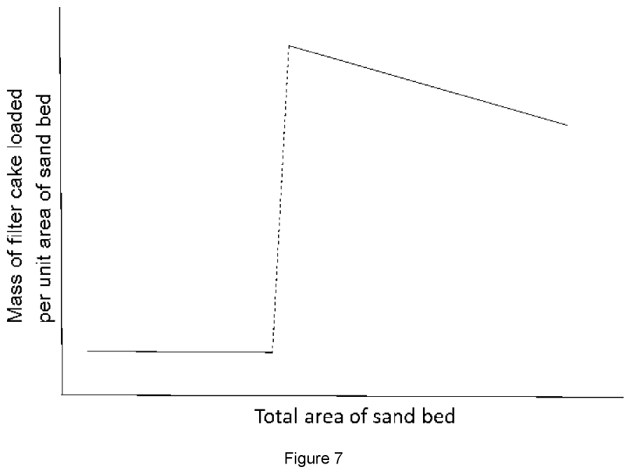

FIG. 7 plots the mass of filter cake collected per unit filtration area (i.e., mass of cake divided by the total area of the filter bed) for a series of different-sized but related sand filters. In other words, FIG. 7 presents the apparent maximum attainable solids loading per unit area of filtration surface as a function of total filtration area. All trials were terminated prior to filter bed saturation (i.e., prior to commencing maintenance). Here, the term “apparent” conveys the notion that the termination time before embarking on filter maintenance is subjective, and open to some variability. Cake loading per unit filtration area is calculated by dividing the total mass of solids retained in the sand bed by the total sand bed surface area. While most of the cake mass is centralized, some solids will be found outside the centralmost region of the sand bed. Hence, said cake loading per square meter calculation depicts a spatially-averaged value, reflecting the uneven distribution of cake along the entirety of the sand bed surface. Viewing the plot from right to left, the mass of deposited cake/m² increases linearly in progressively downsizing the sand bed area, reaching a peak loading value per unit area before suddenly plummeting at even smaller sand bed surface areas. In continuing more to the left, the profile remains flat and the loading per unit area remains small. To ensure proper comparison, a fixed stream influx rate was used. All sand beds were draped using a slightly undersized filter sheet of a fixed sheet-to-bed proportion. A sufficiently powerful vacuum pump was used to ensure that the pumping capacity imposed a consistent effect on the discharge rates of the various different-sized sand beds.

1. A water treatment system suitable for utilization in mobile platform technologies to remove TNT, and potentially other toxicants, and particulate matter from waste stream water, comprising the sequential connection of sub-stations in the following order:
at least one sand filter sub-station, with said sub-station additionally featuring, a filter sheet positioned under a waste stream feed pipe opening, concentrically draped along a similarly-shaped sand bed, configured such that the gap separating the sheet and the pipe opening is the waste stream drop height, h, and configured such that said sheet is slightly undersized so as to cover 92-97% of the sand bed;
said filter sheet is further configured such that the fraction of the sheet draped along a centralmost region of the sand bed serves as the site to feed a waste stream and to support the deposition and growth of a filter cake displaying a hill-like cross-section, and configured such that the fraction of the sheet draped along a ring region and a periphery region of the bed permits through-sheet transfer of the stream to the underlying periphery region and lateral transfer to the undraped perimeter region of the bed;
wherein a vacuum pump is configured to speed the flow of the stream through all filtration media and to discharge a filtrate at the sand filter base, the effect of the above features and configurations being to extend filtration times and operating capacity, maximize cake growth, reduce maintenance down times, and raise the efficiency and utility of the filtration rounds;
at least one ultrafiltration sub-station;
at least one nanofiltration sub-station; and
at least one active granular carbon purification sub-station.

2. A water treatment system according to claim 1, further comprising at least one flocculation tank sub-station to precede the sand filter.

3. A water treatment system according to claim 1, wherein the filter sheet is oversized as opposed to slightly undersized, is overlaid along the entire sand bed, with said oversized filter sheet being configured such that the fraction of sheet covering the centralmost region of the sand bed serves as the site for delivery of the waste stream and buildup of the filter cake, whereas the sheet draped outside of the central region (10.1.1), namely, the sheet overlying the ring, the periphery and the perimeter regions of the sand bed permits the through-sheet passage of the stream to the underlying sand bed such that the through-sheet filtration flux at any particular point along the sheet increases in radially digressing outwards from the central region to the sand filter perimeter wall (9), and conversely, the deposition of solids suspended in the waste stream correspondingly decreases in radially digressing outwards from the central region.

4. A process of utilizing a waste water treatment system according to claim 1, wherein the waste stream is sequentially conveyed via interconnecting conduits to the various sub-stations listed below and processed thereof such that:
the sand filter, fitted with an overlying filter sheet, is covering 92-97% of the sand bed, is configured with a waste stream feed pipe opening or suitable alternative stream delivery source positioned centrally above the sand bed and suspended at a waste stream drop height, h, measuring ¼ to ⅓ of the length of the edge of the filter sheet, is fed the waste stream characterized in that said incoming stream drops onto the filter sheet covering the centralmost region of the sand bed via gravity and further characterized in that said waste stream flows through the sand filter with a flux ranging between 8-13 L of the stream per square meter area of the sand bed per minute, and is producing the filtrate containing particles no larger than 10 microns in size;
the ultrafiltration sub-station is fed the incoming partially purified stream such that the stream is further purified of large dispersed particles;
the nanofiltration sub-station is fed the incoming majorly purified stream such that the stream is further purified of all dispersed particles and potentially a substantial if not the majority of TNT-sized solutes;
the active granular carbon purification sub-station is fed the incoming near-pure stream such that the stream is further purified of all solutes via physico-chemical sequestration as opposed to physical segregation.

5. A process of utilizing a water treatment system according to claim 4, wherein the sand bed may be fitted with a filter sheet that is oversized as opposed to slightly undersized, so as to completely cover the sand bed and potentially further reduce the need and down time required for maintenance operations.

6. A process of utilizing a water treatment system according to claim 4, wherein a flocculation tank precedes the sand filter, and is used to generate flocs and thereby achieve a partial purification of the original waste stream via precipitation of said flocs before said stream is fed into the sand filter.

7. A process of utilizing a water treatment system according to claim 4, wherein the solids subjected to physical separation by the sand filter processing refer primarily to ≥10 and possibly ≥5 micron-sized particulate TNT or other similarly sized organic/inorganic particles comprising of energetic, toxic or inert materials.

8. A process of utilizing a water treatment system according to claim 4, wherein the filter sheet is a chemically inert and optionally anti-static material comprising of either a textile cloth, a porous polymeric filtration membrane, a fine-mesh screen, a cellulose filter paper, or a non-woven fabric, with the lattermost two optionally supported by a reinforcing backing made out of an inert metallic, ceramic or plastic coarse-mesh screen.
